(19) United States
(12) Patent Application Publication
(10) Pub. No.: US 2024/0355613 A1
(43) Pub. Date: Oct. 24, 2024

(54) CONDITIONAL OPERATIONS IN QUANTUM OBJECT CONFINEMENT APPARATUS USING BROADCASTED CONTROL VOLTAGE SIGNALS

(71) Applicant: Quantinuum LLC, Broomfield, CO (US)

(72) Inventors: Christopher E. LANGER, Highlands Ranch, CO (US); Curtis VOLIN, Marietta, GA (US); William Cody BURTON, Northglenn, CO (US); Grahame VITTORINI, St. Louis Park, MN (US)

(21) Appl. No.: 18/468,892

(22) Filed: Sep. 18, 2023

Related U.S. Application Data
(60) Provisional application No. 63/481,665, filed on Jan. 26, 2023.
(60) Provisional application No. 63/379,040, filed on Oct. 11, 2022.

(51) Int. Cl. H01J 49/42; G06N 10/40

(52) U.S. Cl. CPC H01J 49/4245; G06N 10/40; H01J 49/426; H01J 49/422; H01J 49/424

(57) ABSTRACT

A quantum object confinement apparatus configured for performing conditional operations using broadcasted voltage signals is provided. In an example embodiment, the confinement apparatus comprises one or more electrode sequences. Each electrode sequence comprises a respective plurality of control electrodes configured to control the electric potential in a respective trapping region of one or more trapping regions of the confinement apparatus. A first switchable control electrode of the respective plurality of control electrodes is configured to be switchably in electrical communication with a respective selected switchable control voltage source of two or more switchable control voltage sources.

### CROSS-REFERENCE TO RELATED APPLICATIONS

This application claims priority to U.S. Application No. 63/481,665, filed Jan. 26, 2023, and U.S. Application No. 63/379,040, filed Oct. 11, 2022, the contents of which are hereby incorporated by reference in their entireties.

### TECHNICAL FIELD

Various embodiments relate to apparatuses, systems, and methods relating to controlling quantum objects within a quantum object confinement apparatus. For example, some example embodiments relate to the performance of conditional operations on quantum objects confined by a periodic or quasi-periodic array of trapping regions of a quantum object confinement apparatus.

### BACKGROUND

Quantum charge-coupled device (QCCD)-based quantum systems have been shown to be usable for performing quantum computations with a small number of quantum objects. However, to increase the number of quantum objects confined by a confinement apparatus of a QCCD-based quantum system, the size of the confinement apparatus must also increase. Increasing the size of the confinement apparatus requires increasing the number of control electrodes of the confinement apparatus. The infrastructure for providing voltage signals to each of the control electrodes quickly becomes very large and complex. Through applied effort, ingenuity, and innovation many deficiencies of such prior confinement apparatuses and methods of operation therefore have been solved by developing solutions that are structured in accordance with the embodiments of the present invention, many examples of which are described in detail herein.

### BRIEF SUMMARY OF EXAMPLE EMBODIMENTS

Example embodiments provide methods, systems, apparatuses, computer program products and/or the like for performing conditional operations on quantum objects confined by a confinement apparatus having a periodic array or a quasi-periodic array of trapping regions or a plurality of trapping regions having similar and/or a common structure. In various embodiments, the electric potential within each trapping region is defined by a respective electrode sequence comprising a respective plurality of control electrodes. Each electrode sequence comprises a respective plurality of control electrodes that includes one or more switchable control electrodes. The one or more switchable control electrodes comprises a first switchable control electrode and, optionally, a second switchable control electrode. The first switchable control electrode and, optionally, the second switchable control electrode are configured to be switchably in electrical communication with a first switchable control voltage source or a second switchable control voltage source of a plurality of control voltage sources. For example, in an example embodiment, at any particular point in time, the first switchable control electrode is in electrical communication with exactly one of the first switchable control voltage source or the second switchable control voltage source. The switchable configuration of the first switchable control electrode and the second switchable control electrode in each trapping region of the periodic array or quasi-periodic array of trapping regions or in the plurality of trapping regions having similar and/or a common structure are independently controllable. This configuration enables the conditional performance of an operation in one or more trapping regions while enabling the prevention of performance of the operation in other trapping regions.

According to a first aspect, a quantum object confinement apparatus, such as a quantum object confinement apparatus configured for performing conditional operations using broadcasted voltage signals, for example, is provided. In an example embodiment, the quantum object confinement apparatus comprises one or more electrode sequences each comprising a respective plurality of control electrodes. The respective plurality of control electrodes of each electrode sequence is configured to control the electric potential in a respective trapping region of one or more trapping regions of the quantum object confinement apparatus. A first switchable control electrode and, optionally, a second switchable control electrode of the one or more switchable control electrodes of the respective plurality of control electrodes are each configured to be switchably in electrical communication with a respective selected switchable control voltage source of two or more switchable control voltage sources.

In an example embodiment, the respective plurality of control electrodes further comprises one or more broadcast control electrodes that are each configured to be in electrical communication with a respective broadcast control voltage source of one or more broadcast control voltage sources.

In an example embodiment, the one or more electrode sequences each comprise a respective plurality of control electrodes and the one or more broadcast control electrodes of the respective plurality of control electrodes are configured to be in electrical communication with respective ones of the one or more broadcast control voltage sources. For example, a broadcast control voltage source of the one or more broadcast control voltage sources is in electrical communication with respective broadcast control electrodes of each of multiple electrode sequences of the plurality of electrode sequences.

In an example embodiment, a number of the broadcast control voltage sources scales with and/or is proportional to a number of independent broadcast control electrodes in the respective plurality of control electrodes and does not scale with the total number of control electrodes.

In an example embodiment, the quantum object confinement apparatus further comprises one or more switches. Each electrode sequence is associated with a respective switch of the one or more switches and the respective switch is configured to control switching among two or more switch positions, each respective switch position of the two or more switch positions configured to cause the first switchable control electrode to be in electrical communication with a selected one of two or more selectable control voltage sources and to optionally cause the second switchable control electrode of the one or more switchable control electrodes to be in electrical communication with a different one of the two or more selectable control voltage sources.

In an example embodiment, the respective switch is a double-pole double-throw switch.

In an example embodiment, the respective switch is configured to be controlled by a respective switch signal.

In an example embodiment, the respective switch signal is a digital signal.

In an example embodiment, the one or more electrode sequences comprises a plurality of electrode sequences, the one or more switches comprises a plurality of switches, and each switch of the plurality of switches is independently controlled.

In an example embodiment, the respective trapping region of the one or more trapping regions is a cyclic path trapping region; the plurality of voltage control signals partitioned into two subsets of voltage signals labeled the L partition and the R partition respectively; and the respective plurality of control electrodes are configured to (a) when the first switchable control electrode is in electrical communication with the first switchable control voltage source, the plurality of control electrodes are configured to be in electrical communication with the L voltage signal partition, one signal in the L voltage signal partition for each control electrode in the plurality of control electrodes, and causes one or more potential wells formed by the respective plurality of control electrodes to move around the cyclic path trapping region in a first direction and (b) when the first switchable control electrode is in electrical communication with the second switchable control voltage source, the plurality of control electrodes are configured to be in electrical communication with the R voltage signal partition, and causes one or more the potential wells formed by the respective plurality of control electrodes to move around the cyclic path trapping region in a second direction.

According to another aspect, a quantum system is provided. The system comprises a first switchable control voltage source configured to generate a first switchable control voltage signal; a second switchable control voltage source configured to generate a second switchable control voltage signal; and a quantum object confinement apparatus comprising one or more electrode sequences. Each electrode sequence comprises a respective plurality of control electrodes configured to control the electric potential in a respective trapping region of one or more trapping regions of the quantum object confinement apparatus. A first switchable control electrode and a second switchable control electrode of the respective plurality of control electrodes are each configured to be switchably in electrical communication with a respective selected switchable control voltage source of two or more switchable control voltage sources such that a respective selected switchable control voltage signal of two or more switchable control voltage signals is applied thereto. The system further includes a controller configured to control operation of each of the two or more switchable control voltage sources, and with which of the two or more switchable control voltage sources each of the first switchable control electrode and the second switchable control electrode are respectively in electrical communication.

In an example embodiment, the system further comprises one or more broadcast control voltage sources each configured to generate a respective broadcast control voltage signal. The respective plurality of control electrodes further comprises one or more broadcast control electrodes that are each configured to be in electrical communication with a respective broadcast control voltage source of the one or more broadcast control voltage sources such that the respective broadcast control voltage signal is applied thereto.

In an example embodiment, the one or more electrode sequences comprises a plurality of electrode sequences and the one or more broadcast control electrodes of the respective plurality of control electrodes of the plurality of electrode sequences are configured to be in electrical communication with the one or more broadcast control voltage sources.

In an example embodiment, a number of the broadcast control voltage sources is proportional to a number of independent control electrodes in the respective plurality of control electrodes and/or is not proportional to a number of electrode sequences.

In an example embodiment, the quantum object confinement apparatus further comprises one or more switches. Each electrode sequence is associated with a respective switch of the one or more switches and the respective switch is configured to control switching among two or more switch positions, with each respective switch position of the two or more switch positions configured to cause the first switchable control electrode to be in electrical communication with a selected one of two or more selectable control voltage sources and to cause the second switchable control electrode to be in electrical communication with a different one of the two or more selectable control voltage sources.

In an example embodiment, the respective switch is a double-pole double-throw switch.

In an example embodiment, the system further comprises one or more switch signal generators. The controller is configured to control operation of the one or more switch signal generators and the respective switch is configured to be controlled by a respective switch signal generated by a respective switch signal generator of the one or more switch signal generators.

In an example embodiment, the respective switch signal is a digital signal.

In an example embodiment, the one or more electrode sequences comprises a plurality of electrode sequences, the one or more switches comprises a plurality of switches, the one or more switch signal generators comprises a plurality of switch signal generators, and the controller is configured control operation of each switch signal generator of the plurality of switch signal generators independently.

In an example embodiment, the respective trapping region of the one or more trapping regions is a cyclic path trapping region; the plurality of voltage control signals partitioned into two subsets of voltage signals labeled the L partition and the R partition respectively; and the respective plurality of control electrodes are configured to (a) when the first switchable control electrode is in electrical communication with the first switchable control voltage source, the plurality of control electrodes are configured to be in electrical communication with the L voltage signal partition, one signal in the L voltage signal partition for each control electrode in the plurality of control electrodes, and causes one or more potential wells formed by the respective plurality of control electrodes to move around the cyclic path trapping region in a first direction and (b) when the first switchable control electrode is in electrical communication with the second switchable control voltage source, the plurality of control electrodes are configured to be in electrical communication with the R voltage signal partition, and causes one or more the potential wells formed by the respective plurality of control electrodes to move around the cyclic path trapping region in a second direction.

According to another aspect, a quantum system is provided. In an example embodiment, the system comprises a first switchable control voltage source configured to generate a first switchable control voltage signal; a second switchable control voltage source configured to generate a second switchable control voltage signal; a plurality of broadcast control voltage sources each configured to generate a respective broadcast control voltage signal; a quantum object confinement apparatus comprising a plurality of electrode sequences. Each electrode sequence comprises a respective plurality of control electrodes configured to control the electric potential in a respective trapping region of a plurality of trapping regions of the quantum object confinement apparatus. The respective plurality of control electrodes comprises a first switchable control electrode, a second switchable control electrode, and a plurality of broadcast control electrodes. The first switchable control electrode and the second switchable control electrode are each configured to be switchably in electrical communication with a respective selected switchable control voltage source of two or more switchable control voltage sources is applied thereto. Each of the plurality of broadcast control electrodes is in electrical communication with a respective broadcast control voltage source of the plurality of broadcast control voltage sources such that the respective broadcast control voltage source is in electrical communication with respective broadcast control electrodes of at least two electrode sequences. The system further includes a controller configured to control operation of each of the two or more switchable control voltage sources, and with which of the two or more switchable control voltage sources each of the first switchable control electrode and the second switchable control electrode are respectively in electrical communication.

In an example embodiment, the system further comprises a plurality of switch signal generators each configured to generate a respective switch signal. The quantum object confinement apparatus further comprises a plurality of switches and each electrode sequence is associated with a respective switch of the plurality of switches. The respective switch is configured to control switching among two or more switch positions, each respective switch position of the two or more switch positions configured to cause the first switchable control electrode to be in electrical communication with a selected one of two or more selectable control voltage sources and to optionally cause the second switchable control electrode to be in electrical communication with a different one of the two or more selectable control voltage sources. The respective switch is configured to be controlled by a respective switch signal generated by a respective switch signal generator of the plurality of switch signal generators. The controller is configured to independently control operation of each of the plurality of switch signal generators.

In an example embodiment, the controller is configured to cause performance of a conditional operation in a subset of the plurality of trapping regions at least in part by controlling the operation of the plurality of switch signal generators such that (a) for each electrode sequence for which the corresponding trapping region is part of the subset of the plurality of trapping regions within which the conditional operation is to be performed, the respective switch is in a first switch position of the two or more switch positions and (b) for each electrode sequence for which the corresponding trapping region is not part of the subset of the plurality of trapping regions within which the conditional operations is to be performed, the respective switch is in a second switch position of the two or more switch positions.

In an example embodiment, the plurality of trapping regions are one-dimensional trapping regions and performance of the conditional operation in the subset of the plurality of trapping regions comprises moving quantum objects between respective initial positions and respective final positions.

In an example embodiment, the respective initial positions comprise at least one of (a) respective positions along respective trapping regions of the subset of the plurality of trapping regions or (b) respective junctions that link respective trapping regions or that enable transport of a quantum object between the respective trapping regions.

In an example embodiment, the respective final positions comprise at least one of (a) respective positions along respective trapping regions of the subset of the plurality of trapping regions or (b) respective junctions that link respective trapping regions or that enable transport of a quantum object between the respective trapping regions.

In an example embodiment, the controller is configured to control operation of the first switchable control voltage source, the second switchable control voltage source, the plurality of broadcast control voltage sources, and the plurality of switch signal generators such that a set of one or more respective quantum objects confined in the respective trapping region moves along the respective trapping region in (a) a first direction when the respective switch is in the first position and (b) a second direction when the respective switch is in the second position.

In an example embodiment, the controller is configured to identify an operation to be performed; identify one or more trapping regions of the plurality of trapping regions within which the operation is to be performed; determine a respective switch position for each trapping region of the plurality of trapping regions based on whether the operation is to be performed in the respective trapping region; control operation of the plurality of switch signal generators based on the respective switch positions determined for each trapping region of the plurality of trapping regions; and control operation of first switchable control voltage source, the second switchable control voltage source, and the plurality of broadcast control voltage sources to enable performance of the operation within the one or more trapping regions within which the operation is to be performed.

In an example embodiment, the controller is further configured to control operation of first switchable control voltage source, the second switchable control voltage source, and the plurality of broadcast control voltage sources to prevent performance of the operation within trapping regions of the plurality of trapping regions within which the operation is not to be performed.

In an example embodiment, the system further includes a first shim voltage source configured to generate a first shim signal having a first dynamic value; and a second shim voltage source configured to generate a second shim signal having a second dynamic value. In an example embodiment, the second dynamic value is equal to the first dynamic value multiplied by negative one. The quantum object confinement apparatus further comprises respective shim electrodes (a) each associated with respective trapping regions of the plurality of trapping regions and (b) each switchably in electrical communication with one of the first shim voltage source and the second shim voltage source.

In an example embodiment, the quantum object confinement apparatus of the system further comprises respective shim electrodes each associated with respective trapping regions of the plurality of trapping regions and a shim voltage source is configured to apply a shim voltage thereto that is configured to cause a resulting electric field that corrects from stray electric fields and/or manufacturing imperfections.

In an example embodiment, the shim electrode is in electrical communication with a capacitor and the capacitor is in electrical communication with a switch that enables the capacitor to be switched between (a) being in electrical communication with the shim voltage source and (b) not being in electrical communication with the shim voltage source.

In an example embodiment, applying the shim voltage source to the shim electrode comprises the steps of closing the switch such that the capacitor is in electrical communication with the shim voltage source causing the capacitor to be charged to the shim voltage; and opening the switch such that the capacitor maintains the shim voltage.

In an example embodiment, the controller is configured to identify an operation to be performed; identify one or more trapping regions of the plurality of trapping regions within which the operation is to be performed; determine a respective shim signal sign for each trapping region of the plurality of trapping regions based on whether the operation is to be performed in the respective trapping region, wherein the respective shim signal sign for the respective trapping region determines whether the respective shim electrode of the respective trapping region is in electrical communication with the first shim voltage source or the second shim voltage source; control operation of a plurality of switch signal generators based on the respective shim signal sign determined for each trapping region of the plurality of trapping regions; and control operation of first switchable control voltage source, the second switchable control voltage source, and the plurality of broadcast control voltage sources to enable performance of the operation within the one or more trapping regions within which the operation is to be performed.

In an example embodiment, the controller is configured to cause performance of a conditional operation in each of a first subset of the plurality of trapping regions and prevent performance of the conditional operation in each of a second subset of the plurality of trapping regions.

In an example embodiment, the conditional operation is at least one of a junction swap operation, a linear swap operation, a partial row or column shift, arbitrary quantum object sorting, gating of one or more quantum objects, cooling of quantum objects, measurement of quantum objects, initialization of quantum objects, position swapping of quantum objects located within a same trapping region, or another transport or non-transport operation.

In an example embodiment, the plurality of trapping regions forms a periodic array or quasi-periodic array of trapping regions.

In an example embodiment, the plurality of broadcast control voltage sources comprise a first set of broadcast control voltage sources and a second set of broadcast control voltage sources and the plurality of broadcast control electrodes of a given electrode sequence are selectively in electrical communication with respective broadcast control voltage sources of the first set of broadcast sources or the second set of broadcast sources so as to reduce cross-talk between electrode sequences of the plurality of electrode sequences or to effectuate a conditional operation where having more than two switchable control electrodes may simplify operation by reducing maximum voltage levels such as in a cyclic path trapping region when selecting between rotating in a first direction or in a second direction.

In an example embodiment, the given electrode sequence is selectively in electrical communication with the respective broadcast control voltage sources of the first set of broadcast sources or the second set of broadcast sources based on at least one of (a) a switch position of the respective switch of the given electrode sequence or (b) the switch position of the respective switch of a neighboring electrode sequence.

In an example embodiment, a trapping region of the given electrode sequence and a trapping region of the neighboring electrode sequence are joined to one another via a junction.

According to another aspect, a controller configured to control operation of a quantum system is provided. The quantum system comprises a first switchable control voltage source, a second switchable control voltage source, a plurality of broadcast control voltage sources, and a quantum object confinement apparatus comprising a plurality of electrode sequences that each define a respective trapping region. Each electrode sequence of the plurality of electrode sequences comprises a first switchable control electrode configured to be switchably in electrical communication with a selected one of two or more switchable control voltage sources, and a plurality of broadcast control electrodes each configured to be in electrical communication with a respective broadcast control voltage source of the plurality of broadcast control voltage sources. The controller is configured and/or programmed to control operation of each of the two or more switchable control voltage sources, and the plurality of broadcast control voltage sources such that respective quantum objects disposed in a first subset of the plurality trapping regions are moved in a first direction along respective trapping regions and the respective quantum objects disposed in a second subset of the plurality of trapping regions are moved in a second direction along the respective trapping regions. The plurality of broadcast control electrodes corresponding to trapping regions in the first subset of trapping regions are respectively in electrical communication with the same plurality of broadcast control voltage sources as the plurality of broadcast control electrodes corresponding to trapping regions in the second subset of trapping regions.

In example embodiment, the first switchable control electrode corresponding to trapping regions in the first subset of trapping regions are in electrical communication with a same one of the first switchable control voltage source or the second switchable control voltage source.

In an example embodiment, the first switchable control electrode corresponding to trapping regions in the first subset of trapping regions are in electrical communication with an opposite one of the first switchable control voltage source or the second switchable control voltage source with respect to the first switchable control electrode corresponding to trapping regions in the second subset of trapping regions.

In an example embodiment, the quantum system further comprises a first shim voltage source configured to generate a first shim signal having a first dynamic value and a second shim voltage source configured to generate a second shim signal having a second dynamic value. In an example embodiment, the second dynamic value is equal to the first dynamic value multiplied by negative one. The quantum object confinement apparatus further comprises respective shim electrodes (a) each associated with respective trapping regions of the plurality of trapping regions and (b) each switchably in electrical communication with one of the first shim voltage source and the second shim voltage source, and the shim electrode corresponding to trapping regions in the first subset of trapping regions are in electrical communication with a same one of the first shim voltage source or the second shim voltage source.

In an example embodiment, the quantum system further comprises a first shim voltage source configured to generate a first shim signal having a first dynamic value and a second shim voltage source configured to generate a second shim signal having a second dynamic value. In an example embodiment, the second dynamic value is equal to the first dynamic value multiplied by negative one. The quantum object confinement apparatus further comprises respective shim electrodes (a) each associated with respective trapping regions of the plurality of trapping regions and (b) each switchably in electrical communication with one of the first shim voltage source and the second shim voltage source, and the shim electrode corresponding to trapping regions in the first subset of trapping regions are in electrical communication with a different one of the first shim voltage source or the second shim voltage source with respect to the shim electrode corresponding to trapping regions in the second subset of trapping regions.

In an example embodiment, the plurality of trapping regions forms a periodic array of trapping regions or a quasi-periodic array of trapping regions.

According to yet another aspect, a quantum system is provided. The system comprises a first switchable control voltage source configured to generate a first switchable control voltage signal; a second switchable control voltage source configured to generate a second switchable control voltage signal; a plurality of broadcast control voltage sources each configured to generate a respective broadcast control voltage signal; and a quantum object confinement apparatus comprising one or more electrode sequences. Each electrode sequence comprises a respective plurality of broadcast control electrodes and a respective shim electrode configured to control the electric potential in a respective trapping region of one or more trapping regions of the quantum object confinement apparatus. The shim electrode is configured to be switchably in electrical communication with a respective selected switchable control voltage source of two or more switchable control voltage sources such that a respective selected switchable control voltage signal of two or more switchable control voltage signals is applied thereto. Each of the broadcast control electrodes are configured to be in electrical communication with a respective broadcast control voltage source of the plurality of broadcast control voltage sources. The system further includes a controller configured to control operation of each of the two or more switchable control voltage sources, and with which of the two or more switchable control voltage sources the shim electrode is in electrical communication.

According to still another aspect, a method performed by a controller of a quantum system for causing the quantum system to perform a conditional operation is provided. The method comprises identifying a first set of trapping regions in which the conditional operation is to be performed and a second set of trapping regions in which the conditional operation is not to be performed, wherein respective electric potentials of the respective trapping regions of the first set of trapping regions and the second set of trappings are each defined by a respective electrode sequence of a confinement apparatus of the quantum system. The respective electrode sequence comprises a first switchable control electrode configured to be switchably in electrical communication with a selected one of two or more switchable control voltage sources, and a plurality of broadcast control electrodes each configured to be in electrical communication with a respective broadcast control voltage source of a plurality of broadcast control voltage sources. The method further comprises controlling operation of the first switchable control voltage source, the second switchable control voltage source, the broadcast control voltage sources, and which of the first switchable control voltage source or the second switchable control voltage source each of the first switchable control electrode and the second switchable control electrode is in electrical communication with such that respective quantum objects disposed in the first subset of the plurality trapping regions are moved in a first direction along respective trapping regions and the respective quantum objects disposed in the second subset of the plurality of trapping regions are moved in a second direction along the respective trapping regions. The method further comprises controlling operation of one or more components of the quantum system to cause the conditional operation to be performed on the respective quantum objects in the first subset of the plurality of trapping regions.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1A provides a top view of at least a portion of an example quantum object confinement apparatus that may be used in an example embodiment.

FIG. 1B provides a schematic diagram of the electrode sequences corresponding to two linear trapping regions, in accordance with an example embodiment.

FIG. 1C provides a schematic diagram of two electrode sequences corresponding to a cyclic path trapping region, in accordance with an example embodiment.

FIG. 1D provides a top view of at least a portion of another example quantum object confinement apparatus that may be used in an example embodiment.

FIG. 2 provides a diagram showing an example scheme for performing a conditional motion primitive, in accordance with an example embodiment.

FIG. 3 is a diagram showing another example scheme for performing a conditional motion primitive, in accordance with an example embodiment.

FIGS. 4A-4G provide a schematic representation of a conditional junction swap operation, in accordance with an example embodiment.

FIGS. 5A-5D provide a schematic representation of a conditional linear swap operation, in accordance with an example embodiment.

FIGS. 6A-6D provide a schematic representation of a conditional non-transport operation, in accordance with an example embodiment.

FIGS. 7A-7D provide a schematic representation of a partial row shift operation, in accordance with an example embodiment.

FIG. 8 provides a schematic representation of a conditional motion primitive where a quantum object is initially located at a junction between a set of linear trapping regions, in accordance with an example embodiment.

FIG. 9 is a schematic diagram illustrating an example quantum computing system comprising a quantum object confinement apparatus having a periodic or quasi-periodic array of trapping regions and configured to perform conditional operations, according to various embodiments.

FIG. 10 provides a schematic diagram of an example controller of a quantum computer configured to perform one or more deterministic reshaping and/or reordering functions, according to various embodiments.

FIG. 11 provides a flowchart illustrating various processes, procedures, and/or operations performed by a controller of FIG. 10, for example, for performing a conditional operation, according to various embodiments.

FIG. 12 provides a schematic diagram of an example computing entity of a quantum computer system that may be used in accordance with an example embodiment.

### DETAILED DESCRIPTION OF SOME EXAMPLE EMBODIMENTS

The present invention now will be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. The term “or” (also denoted “/”) is used herein in both the alternative and conjunctive sense, unless otherwise indicated. The terms “illustrative” and “exemplary” are used to be examples with no indication of quality level. The terms “generally” and “approximately” refer to within engineering and/or manufacturing limits and/or within user measurement capabilities, unless otherwise indicated. Like numbers refer to like elements throughout.

Example embodiments provide methods, systems, apparatuses, computer program products and/or the like for performing conditional operations on quantum objects confined by a confinement apparatus having a plurality of trapping regions. In various embodiments, the confinement apparatus comprises a plurality of trapping regions that have similar and/or a common structure (e.g., the same electrode or other controlling structure layout and/or arrangement, the same dimensions, and/or the like). In various embodiments, the plurality of trapping regions is arranged in a periodic array or a quasi-periodic array of trapping regions.

Various embodiments provide and/or provide methods for use with various confinement apparatuses. For example, the confinement apparatus may be an optical trap, magnetic trap, dipole trap, quadrupole trap, and/or the like comprising a plurality of trapping regions of similar and/or a common structure. The confinement apparatus is configured to confine a respective type of quantum object (e.g., neutral atom/molecule, charged/ionic atom/molecule, quantum particle, quantum dot, and/or the like). One or more trapping regions of the confinement apparatus comprises respective switchable control elements that are switchably in communication with two or more switchable control signals provided by respective switchable confinement control field sources. The ability to select between the two or more switchable control signals enables the performance of conditional operations within the respective trapping regions. Various embodiments are described herein with respect to a quadrupole ion trap (e.g., a surface ion trap configured to confine ions). However, based on the disclosure provided herein, one of ordinary skill in the art would be able to implement various embodiments using other forms of confinement apparatuses.

In various embodiments where the confinement apparatus is an ion trap, the trapping regions of the confinement apparatus are defined by electric potential. In various embodiments, the electric potential within each trapping region is defined by a respective electrode sequence. Each electrode sequence comprises a respective plurality of control electrodes, including one or more switchable control electrodes. In various embodiments, the one or more switchable control electrodes include a first switchable control electrode. In various embodiments, the one or more switchable control electrodes includes a second switchable control electrode and, possibly, additional switchable control electrodes, in addition to the first switchable control electrode. The first switchable control electrode and, when present, the second switchable control electrode are configured to be switchably and/or alternately in electrical communication with a first switchable control voltage source or a second switchable control voltage source of a plurality of voltage sources. For example, in an example embodiment, at any particular point in time, the first switchable control electrode is in electrical communication with exactly one of the first switchable control voltage source or the second switchable control voltage source. The switchable configuration of the first switchable control electrode and the second switchable control electrode in each trapping region of the plurality of trapping regions are independently controllable. This configuration enables the conditional performance of an operation in one or more trapping regions while enabling the prevention of performance of the operation in other trapping regions.

In various embodiments, a confinement apparatus is an apparatus configured to confine quantum objects using electromagnetic fields. For example, the confinement apparatus is configured to trap one or more quantum objects in one or more electric potential wells, in an example embodiment. In an example embodiment, the confinement apparatus is an ion trap, such as a surface ion trap and/or a Paul ion trap.

In various embodiments, the confinement apparatus is configured to confine quantum objects in respective one-dimensional trapping regions of a plurality of trapping regions. In various embodiments, the one-dimensional trapping regions are linear, round (e.g., circular, elliptical, and/or the like), curved, and/or other one-dimensional shape. In various embodiments, the trapping regions of the plurality of trapping regions have a common structure. For example, each of the plurality of trapping regions is defined by an electrode layout which is common to each of the plurality of trapping regions. For example, each of the plurality of trapping regions respective electrode sequences that are substantially the same in electrode size, positioning, ordering/positioning of broadcast control electrodes, shim electrodes, RF electrodes, ground electrodes, and switchable control electrodes and/or the like.

In various embodiments, the one-dimensional trapping regions are connected to other one-dimensional trapping regions through junctions to form a two- or three-dimensional periodic array or quasi-periodic array of trapping regions. A quasi-periodic array is an array in which the periodicity of the array is perturbed by a global distortion. In other words, a quasi-periodic array is nearly periodic, but the periodicity is perturbed in one or more dimensions. In various embodiments, the periodic or quasi-periodic array of trapping regions may be similar to the arrays of trapping regions described in U.S. application Ser. No. 17/910,082, filed Jun. 30, 2022, the content of which is incorporated herein by reference in its entirety.

In various embodiments, a quantum object is an object that can be confined by the confinement apparatus and that has a plurality of quantum states that may be manipulated while the quantum object is confined by the confinement apparatus. For example, in various embodiments, the quantum object is a neutral or ionic atom; a neutral, charged, or multi-pole molecule; a quantum particle, and/or the like. In various embodiments, a quantum object is a group of two or more neutral or ionic atoms, neutral, charged, or multi-pole molecules, quantum particles, and/or the like. For example, in various embodiments, the quantum object is a singly ionized ytterbium atom, a singly ionized barium atom, or an ionic crystal comprising one or more singly ionized ytterbium atoms and/or one or more singly ionized barium atoms. In various embodiments, the quantum object is or comprises a singly ionized calcium atom, a singly ionized strontium atom, a singly ionized magnesium atom, a singly ionized beryllium atom, a singly ionized mercury atom, and/or the like.

In various embodiments, the confinement apparatus is configured such that an operation may be performed in parallel in two or more trapping regions of the plurality of trapping regions. For example, the quantum system comprising the confinement apparatus may be configured such that a manipulation signal (e.g., one or more laser beams, magnetic field, a magnetic field gradient, electric field, other field, or the like) can be emitted across a portion of the confinement apparatus such that the manipulation signal can interact with quantum objects in a plurality of trapping regions.

However, it may not always be desired to perform the operation in each of the two or more trapping regions within which the operation could be performed in parallel. For example, the confinement apparatus may be configured such that Operation X may be able to be performed in parallel in trapping regions A, B, C, and D. However, in an example scenario, it is only desired to perform the operation in trapping regions A, B, and C.

In a conventional confinement apparatus, the electromagnetic field and/or electric potential within each trapping region is independently controllable due to each control electrode of the confinement apparatus being independently provided with a control voltage signal. For example, in a conventional confinement apparatus, each control electrode is in electrical communication with a control voltage source and the number of control voltage sources is equal to the total number of control electrodes across all trapping regions. This means that the confinement apparatus includes a trace or lead for each individual control electrode and that the quantum system includes at least as many voltage sources as there are control electrodes.

For small confinement apparatuses configured to confine a small number (e.g., twenty to thirty or less) quantum objects, the infrastructure for enabling providing independent control voltage signals to each control electrode is manageable. However, for a large confinement apparatus configured to confine a large number (e.g., fifty, a hundred, or more) quantum objects, the number of control voltage sources and the number of leads for enabling providing independent control voltage signals to each control electrode becomes large and the system becomes quite complex. For example, enabling sufficient connections points for the leads on the chip comprising the confinement apparatus becomes a challenge. Additionally, the number of independent voltage sources, voltage signal filters, feedthroughs into the cryostat and/or vacuum chamber containing the confinement apparatus all become too large to be efficiently managed. Thus, technical problems exist regarding how to provide voltage signals to the control electrodes of a large confinement apparatus while enabling sufficient independent control of the trapping regions to enable performance of conditional operations.

Various embodiments provide technical solutions to these technical problems. For example, in various embodiments, the quantum object confinement apparatus comprises one or more electrode sequences with each electrode sequence comprising a respective plurality of control electrodes that are configured to control the electric potential in a respective trapping region of the plurality of trapping regions of the quantum object confinement apparatus. Each respective plurality of control electrodes includes a first switchable control electrode and possibly a second switchable control electrode of one or more switchable control electrodes that are each configured to be switchably and/or alternately in electrical communication with a plurality of switchable control voltage sources.

In an example embodiment, each respective plurality of control electrodes further comprises a plurality of broadcast control electrodes that are each configured to be in electrical communication with a respective broadcast control voltage source of a plurality broadcast control voltage sources. For example, a first broadcast control electrode of a first trapping region and a first broadcast control electrode of a second trapping region are in electrical communication with the same broadcast control voltage source.

Similarly, each of the first switchable control electrodes and possibly second switchable control electrodes of the one or more switchable control electrodes are each respectively in (switchable) electrical communication with one of the pluralities of switchable control voltage sources. This enables the number of control voltage sources, chip interconnects, and the like to scale with the number of control electrodes in each electrode sequence. In particular, this enables the number of control voltage sources, chip interconnects, and the like to not scale with the number of electrode sequences while still enabling performance of conditional operations. Thus, various embodiments provide technical improvements to the field of confinement apparatuses and quantum systems (e.g., QCCD-based quantum systems).

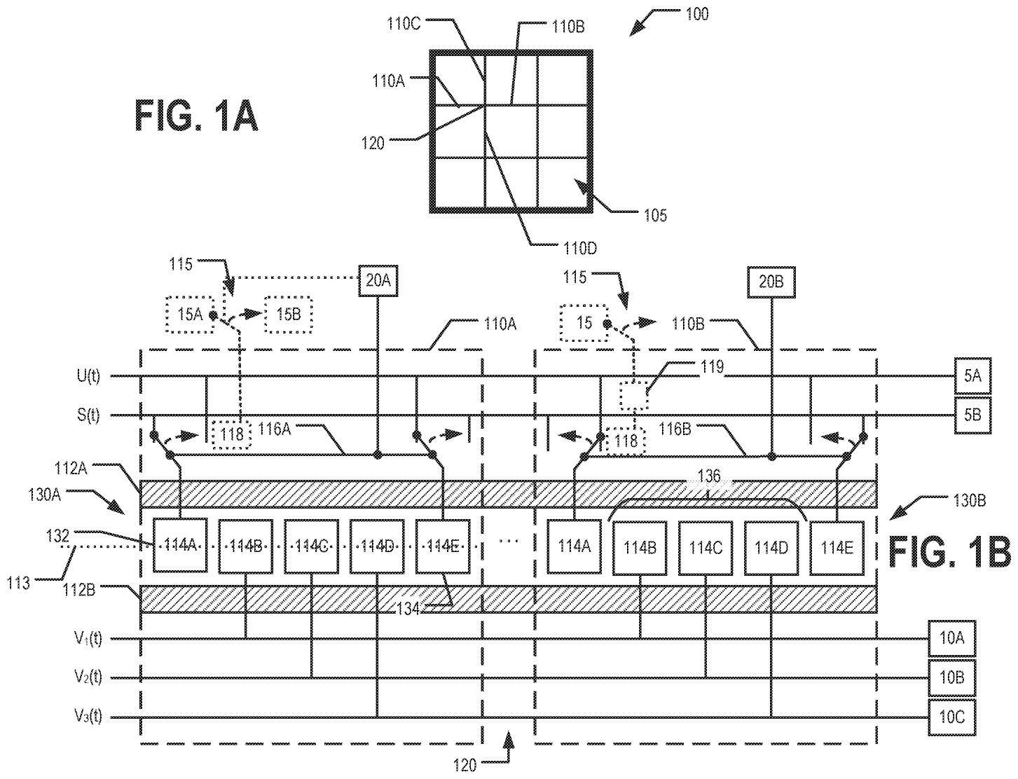

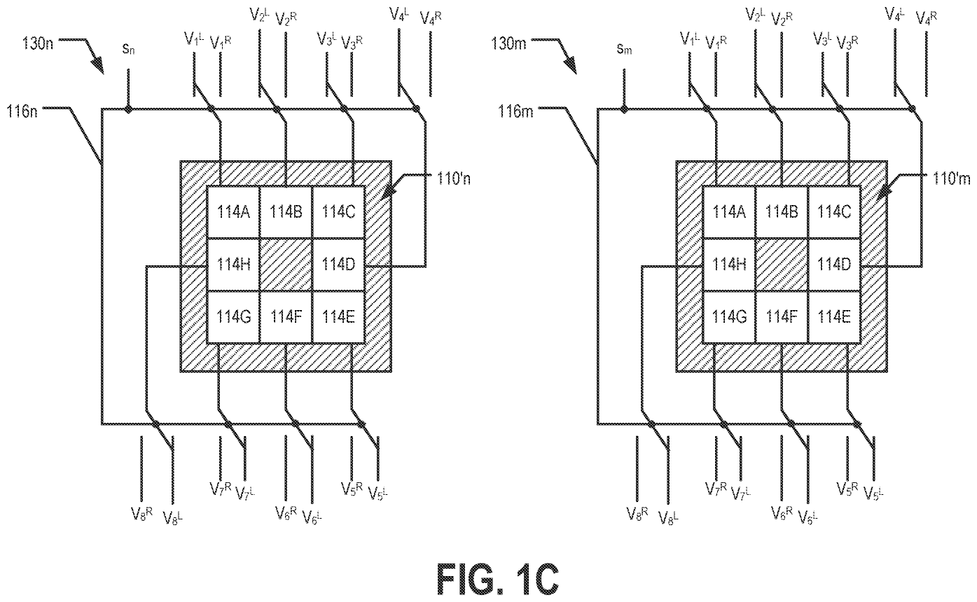

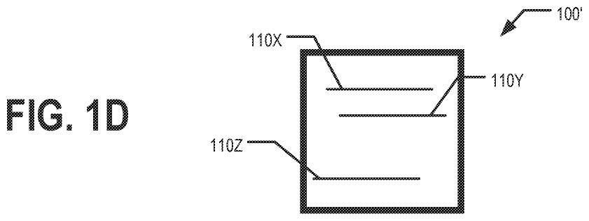

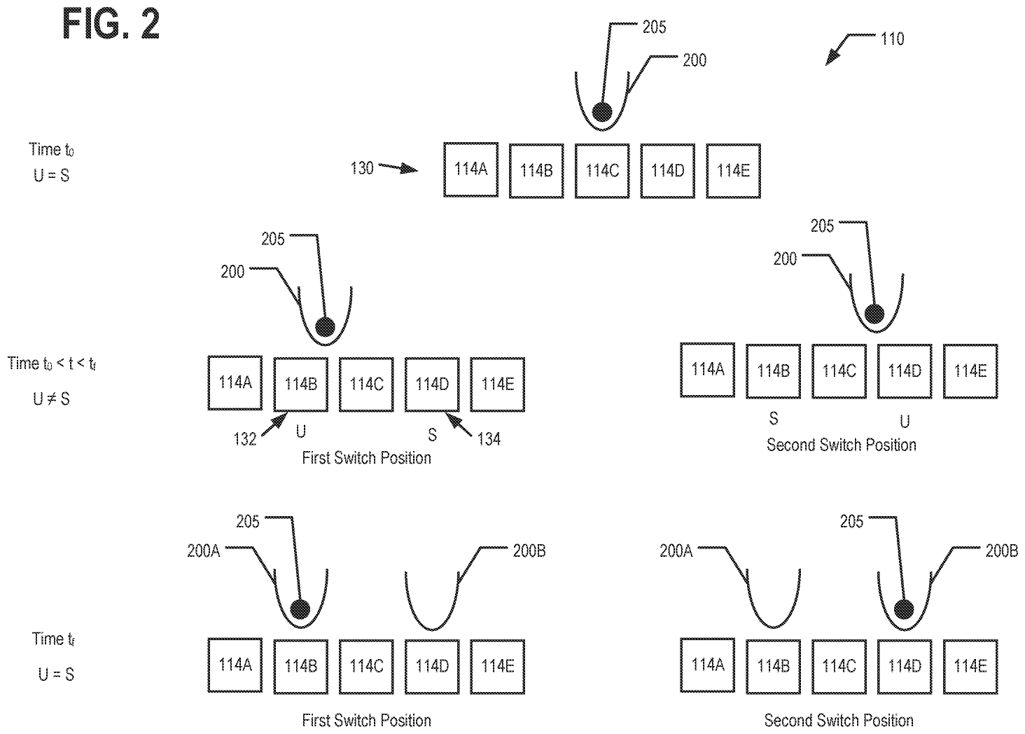

FIG. 1A provides a schematic diagram of an example confinement apparatus 100 that comprises a plurality of one-dimensional trapping regions 110 (e.g., 110A, 110B, 110C, 110D). The respective trapping regions 110 are connected to other trapping regions of the confinement apparatus 100 via junctions 120. For example, trapping regions 110A, 110B, 110C, 110D are connected to one another via junction 120. As used herein, the trapping regions 110A, 110B, 110C, and 110D are connected to another via junction 120 in the sense that one or more quantum objects disposed in trapping region 110A may be transported to any of trapping regions 110B, 110C, or 110D via the junction 120. In the illustrated embodiment, the trapping regions are arranged and/or configured to provide a periodic or quasi-periodic array 105 of trapping regions 110.

FIG. 1B provides a schematic diagram of trapping regions 110A and 110B. In various embodiments, the confinement apparatus 100 comprises one or more radio frequency (RF) electrodes, referred to as RF rails 112 (e.g., 112A, 112B) herein. A periodic voltage signal (e.g., having radio frequency periodicity) is applied to the RF rail(s) 112 to generate a confining or trapping pseudopotential that generally defines the one-dimensional trapping regions 110.

The electric potential along the axis 113 of the trapping region 110 is controlled by an electrode sequence 130 (e.g., 130A, 130B). In various embodiments, an electrode sequence 130 comprises a respective plurality of control electrodes 114 (e.g., 114A, 114B, 114C, 114D, 114E).

In various embodiments, each control electrode 114 is in communication with a respective control voltage source (via wires, leads, traces, and/or the like) such that a time varying direction current (DC) control voltage signal generated by the respective control voltage source is applied to the respective control electrode 114. In various embodiments, the control voltage signals provided to each of the plurality of control electrodes of an electrode sequence 130 is configured to define an electric potential well within the respective trapping region 110 corresponding to the electrode sequence 130. As used herein, an electrode sequence 130A corresponds to trapping region 110A when the electrode sequence 130A is configured to control the electric potential in the trapping region 110A. The control voltage signal may be varied over time to cause one or more electric potential wells to move along the one-dimensional trapping region. When two electric potential wells are present, the electric potential wells may be moved in the same or different directions along the one-dimensional trapping region 110 based on the control voltage signals applied to the electrodes 114 of the electrode sequence 130.

As should be understood, FIG. 1B illustrates one example control electrode configuration. Various other embodiments may include more or fewer than five control electrodes 114 in each sequence of control electrodes 130. In various embodiments, an electrode sequence of control electrodes 114 may include control electrodes 114 disposed outside of the RF rails 112 and/or between the RF rails 112. In an example embodiment, an electrode sequence may include one or more control electrodes that are neither switchable control electrodes nor broadcast control electrodes.

It should be understood that FIG. 1A illustrates one example of a periodic or quasi-periodic array of trapping regions. Various other embodiments include a plurality of trapping regions that each have a common structure (e.g., are defined by respective electrode sequences that are substantially the same), having zero or more broadcast electrodes and one or more switchable control electrodes, which may or may not be interconnected by junctions and may or may not have periodic or quasi-periodic array form. For example, FIG. 1D illustrates an example quantum object confinement apparatus 100′ that includes a plurality of trapping regions 110 (e.g., 110X, 110Y, 110Z) that each have substantially the same structure (e.g., are defined by respective electrode sequences that are substantially the same and/or similar to one another) that does not form a periodic or quasi-periodic array of trapping regions.

The plurality of control electrodes 114 of an electrode sequence 130 comprises a first switchable control electrode 132 and a second switchable control electrode 134. The first switchable control electrode 132 and the second switchable control electrode 134 are configured to be switchably and/or alternately connected into electrical communication with one of a first switchable control voltage source 5A and a second switchable control voltage source 5B via a control switch 116 (e.g., 116A, 116B). The first switchable control voltage source 5A is configured to generate and provide a first switchable control voltage signal U(t). In various embodiments, the first switchable control voltage signal U(t) is a dynamic analog voltage signal. The second switchable control voltage source 5B is configured to generate and provide a second switchable control voltage source S(t). In various embodiments, the second switchable control voltage signal S(t) is a dynamic analog voltage signal.

As illustrated, control switch 116B is in a first switch position where the first switchable control electrode 132 is in electrical communication with a first switchable control voltage source 5A and the second switchable control electrode 134 is in electrical communication with a second switchable control voltage source 5B. Control switch 116A in a second switch position where the first switchable control electrode 132 is in electrical communication with the second switchable control voltage source 5B and the second switchable control electrode 134 is in electrical communication with the first switchable control voltage source 5A.

In an example embodiment, the control switch 116 is a double-pole double-throw switch. Other forms of switches may be used in various other embodiments, as appropriate for the application.

In various embodiments, the control switch 116 of a respective trapping region 110 is independently operable and/or controllable. As used herein, independently controllable means that the state or output of an element is independent of the state or output of each of the other like elements of the confinement apparatus. For example, the switch position of a first control switch 116A is configured to be independent of the switch position of all the other switches 116 of the confinement apparatus 100.

In various embodiments, the control switch 116 is controlled by a switch signal. For example, the switch is in electrical communication with a switch signal generator 20 (e.g., 20A, 20B). In an example embodiment, the switch signal generator is a digital signal generator. For example, in the illustrated embodiment, the switch signal is a single bit digital signal (e.g., either a first voltage representing “0” or a second voltage representing “1”). For example, when the switch signal is a first voltage, the switch is switched to and/or maintained in a first switch position and when the switch signal is a second voltage, the switch is switched to and/or maintained in a second switch position. Switching or changing the switch position changes with which of the first and second switchable control voltage sources 5A, 5B the first and second switchable control electrodes 132, 134 are in electrical communication.

In an example embodiment, the first switchable control electrode 132 is always in electrical communication with an opposite one of the first switchable control voltage source 5A and the second switchable control voltage source 5B with respect to the second switchable control electrode 134. In an example embodiment, the first switchable control electrode 132 is always in electrical communication with a same one of the first switchable control voltage source 5A and the second switchable control voltage source 5B with respect to the second switchable control electrode 134 For example, the switchable electrical communication between the first switchable control electrode 132 and the first and second switchable control voltage sources 5A, 5B and the switchable electrical communication between the second switchable control electrode 134 and the first and second switchable control voltage sources 5A, 5B is controlled by a single control switch 116. For example, switching which of the first and second switchable control voltage sources 5A, 5B that the first switchable control electrode 132 is in electrical communication with also changes which of the first and second switchable control voltage sources 5A, 5B that the second switchable control electrode 134 is in electrical communication with.

In various embodiments, the control switch 116 may define more than two switch positions. For example, in an example embodiment, a control switch 116 is switchable among two or more switch positions and each respective switch position of the two or more switch positions is configured to cause the first switchable control electrode to be in electrical communication with a selected one of two or more selectable control voltage. In various embodiments, more than two control electrodes 114 are in communication with a control switch 116. In various embodiments, a trapping region 110 may be associated with more than one control switch 116. For example, a control switch 116 may be configured to enable switchable control of placing the first switchable control electrode 132 and the second switchable control electrode 134 into electrical communication with more than two switchable control voltage sources. In another example, a second switch of a trapping region 110 may be configured to enable switchable control of placing a third switchable control electrode and a fourth switchable control electrode each into electrical communication with a respective selected one of a third switchable control voltage source and a fourth switchable control voltage source. For example, in various embodiments, N switchable control voltage sources are switchably and/or alternately in electrical communication with M control electrodes 114 of each trapping region 110 of the periodic or quasi-periodic array 105 and/or plurality of trapping regions 110 of the confinement apparatus 100, where N and M are integers greater than zero.

As illustrated in FIG. 1B, the first switchable control voltage source 5A and the second switchable control voltage source 5B are in electrical communication with respective electrodes 114 of both the trapping region 110A and the trapping region 110B. In various embodiments, the first switchable control voltage source 5A and the second switchable control voltage source 5B are in electrical communication with respective control electrodes 114 of each trapping region 110 of the periodic or quasi-periodic array 105 and/or plurality of trapping regions 110 of the confinement apparatus 100. In other words, in various embodiments, the number of switchable control voltage sources 5 does not scale with the number of trapping regions 110 of the confinement apparatus 100. For example, a quantum system comprising a confinement apparatus comprising 100 trapping regions may include the same number of switchable control voltage sources as a quantum system comprising a confinement apparatus comprising 10,000 trapping regions. However, the switchable electrical connection between the respective switchable control electrodes and the respective switchable control voltage sources 5 enables conditional performance of operations in each of the trapping regions 110.

In various embodiments, the plurality of control electrodes 114 of an electrode sequence 130 comprises one or more broadcast control electrodes 136. In various embodiments, each broadcast control electrode 136 is configured to be in electrical communication with a respective one of one or more broadcast control voltage sources 10 (e.g., 10A, 10B, 10C). In various embodiment, each broadcast control voltage source 10 is configured to generate and provide a respective broadcast control voltage signal V(t) (e.g., V₁(t), V₂(t), V₃(t)). In various embodiments, the broadcast control voltage signals are analog voltage signals.

In various embodiments, the electrical communication between a broadcast control electrode 136 and the respective broadcast control voltage source 10 is stable, consistent, and/or not changing throughout the operation of a quantum system comprising the confinement apparatus 100 comprising the broadcast control electrode 136. For example, the control electrode 114B of trapping region 110A and the control electrode 114B of trapping region 110B are always in electrical communication with a first broadcast control voltage source 10A throughout operation of a quantum system comprising the confinement apparatus 10 and the first broadcast control voltage source 10A.

As illustrated in FIG. 1B, the broadcast control voltage sources 10 are in electrical communication with respective broadcast control electrodes 136 of both the trapping region 110A and the trapping region 110B. The broadcast control voltage sources 10 are referred to as “broadcast” herein due to the voltage signals generated by the broadcast control voltage signals being provided to a plurality of respective broadcast control electrodes 136 of respective trapping regions. In various embodiments, the broadcast control voltage sources 10 are in electrical communication with respective broadcast control electrodes 136 of each trapping region 110 of the periodic or quasi-periodic array 105 and/or plurality of trapping regions 110 of the confinement apparatus 100. In other words, in various embodiments, the number of broadcast control voltage sources 5 does not scale with the number of trapping regions 110 of the confinement apparatus 100. For example, a quantum system comprising a confinement apparatus comprising 100 trapping regions may include the same number of broadcast control voltage sources as a quantum system comprising a confinement apparatus comprising 10,000 trapping regions (given that both confinement apparatuses have the same number of control electrodes and/or broadcast control electrodes per electrode sequence).

In various embodiments, the broadcast control voltage sources 10 are in electrical communication with respective broadcast control electrodes 136 of each trapping region 110 of the periodic or quasi-periodic array 105 and/or plurality of trapping regions 110 of the confinement apparatus 100. Thus, the electric potential generated by a first electrode sequence 130A is the same as the electric potential generated by a second electrode sequence 130B when the first control switch 116A coupled to the first electrode sequence 130A and the second control switch 116B coupled to the second electrode sequence 130B are in the same switch position. However, the electric potential generated by a first electrode sequence 130A is different from the electric potential generated by a second electrode sequence 130B when the first control switch 116A coupled to the first electrode sequence 130A and the second control switch 116B coupled to the second electrode sequence 130B are in different switch positions. Thus, in an example embodiment, a conditional operation may be performed in each trapping region 110 having the corresponding control switch 116 in a first switch position and the performance of the conditional operation is prevented in each trapping region 110 having the corresponding control switch 116 in a second switch position.

In various embodiments, the plurality of trapping regions 110 are divided into groups. For example, for the periodic or quasi-periodic array 105, the trapping regions 110 may be divided into a group of horizontal trapping regions, including trapping regions 110A and 110B, and a group of vertical trapping regions, including trapping regions 110C and 110D. In an example embodiment, a set of broadcast control voltage sources 10 is provided for each group of trapping regions. For example, trapping regions 110A and 110B comprise broadcast control electrodes 136 that are each in electrical communication with a respective broadcast control voltage source of a first set of broadcast control voltage sources and trapping regions 110C and 110D comprise broadcast control electrodes 136 that are each in electrical communication with a respective broadcast control voltage source of a second set of broadcast control voltage sources. For example, this enables independent control of operations performed in “vertical” trapping regions and operations performed in “horizontal” trapping regions while the number of voltage sources required does not scale with the number of trapping regions in the plurality of trapping regions.

In various embodiments, the trapping regions 110 are divided into groups based on sub-arrays of the confinement apparatus 100. In various embodiments, the plurality of trapping regions 110 are divided into groups based on dimensions and/or directions of the period or quasi-periodic array 105. For example, if the periodic or quasi-periodic array 105 of trapping regions 110 is a two-dimensional array, the trapping regions 110 may be divided into two groups where each group represents one of the dimensions of the array (e.g., horizontal and vertical in the example provided above). If the periodic or quasi-periodic array 105 is a three-dimensional array, the trapping regions 110 may be divided into three groups where each group represents one of the dimensions of the array, for example. In various embodiments, the trapping regions 110 may be divided into a number of groups based on factors other than the dimension of the trapping apparatus. For example, groups may be designated for certain operational purposes such as gating, initialization, measurement, loading, storage, cooling, or other functions necessary for the operation of the quantum system.

In an example embodiment, the plurality of broadcast control voltage sources 10 comprise a first set of broadcast control voltage sources and a second set of broadcast control voltage sources. The plurality of broadcast control electrodes of a given electrode sequence are selectively in electrical communication with respective broadcast control voltage sources of the first set of broadcast sources or the second set of broadcast sources so as to reduce crosstalk between sequences of electrodes of the plurality of sequences of electrodes. For example, in an example embodiment, the determination of whether the broadcast control electrodes of a given electrode sequence are in electrical communication with respective broadcast control voltage sources of the first of broadcast control voltage sources or the second set of broadcast control voltage sources is determined based on the whether the switch position of one or more adjacent electrode sequences is the same or a different switch position as the given electrode sequence.

In another example embodiment, the switchable control voltage sources comprise more than two switchable control voltage sources that are each configured to generate and provide a respective switchable control voltage signal. The control switches 116 are configured to enable switching electrical communication of the first and second switchable control electrodes 132, 134 among the more than two switchable control voltage sources. For example, the controller 30 may determine whether to place the first and second switchable control electrodes 132, 134 of a respective electrode sequence in electrical communication with respective ones of a first switchable control voltage source and a second switchable control voltage source or with respective ones of a third switchable control voltage source and a fourth switchable control voltage source based at least in part on the assigned switch positions of adjacent trapping regions so as to reduce any possible cross-talk between trapping regions.

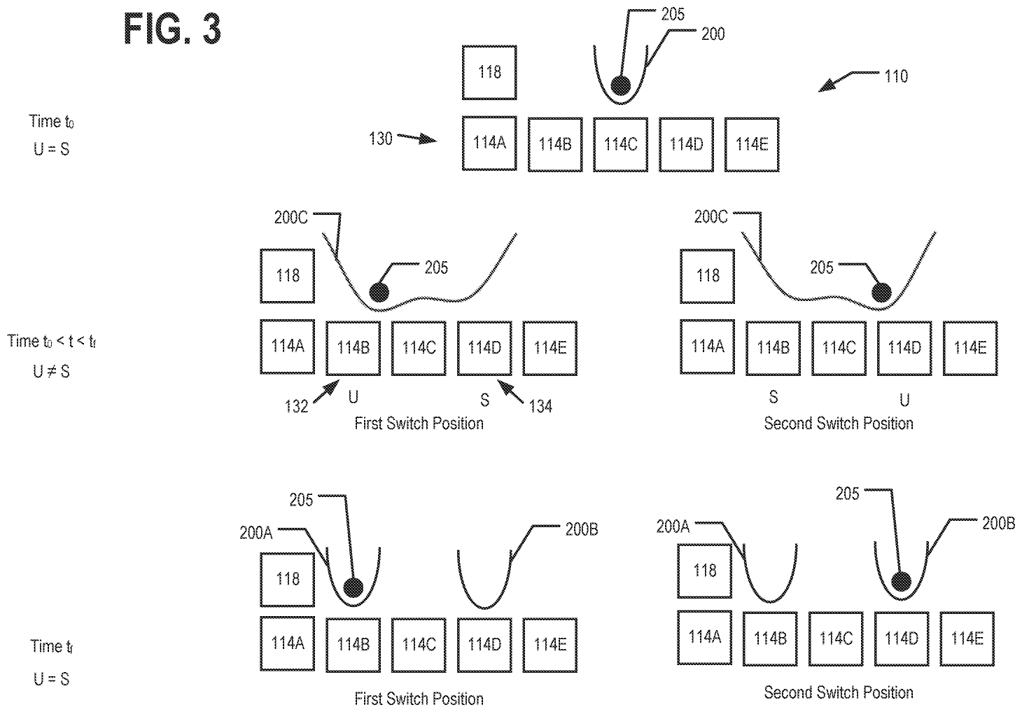

FIG. 2 provides a schematic diagram of the performance of a conditional motion primitive. For example, FIG. 2 shows an electric potential well 200 generated by an electrode sequence 130 in a one-dimensional trapping region 110. At time t₀ a potential well 200 is located in the center of the trapping region 110 and a quantum object 205 is disposed within the potential well 200, as shown in the top row of FIG. 2. As should be understood, in various scenarios, one or more quantum objects could be disposed within the potential well 200 and a single quantum object 205 is illustrated in FIG. 2 for clarity. At time t₀ the first switchable control signal U is substantially equal to the second switchable control signal S.

The middle row of FIG. 2 illustrates the performance of the conditional motion primitive at time t, where t₀<t<t_{f} for the scenario where the corresponding control switch 116 is in a first position (left) and the scenario where the corresponding control switch 116 is in a second position (right). At the intermediate time t between the initial time t₀ and the final time t_{f}, the first switchable control signal U is not equal to the second switchable control signal S. In particular, an electric potential well 200 is moved from a position over control electrode 114C toward a position over control electrode 114B when the control switch 116 is in the first switch position and toward a position over control electrode such that the first switchable control signal U is applied to control electrode 114B and the second switchable control signal is applied to control electrode 114D. Similarly, an electric potential well 200 is moved from the position over control electrode 114C toward a position over control electrode 114D when the control switch 116 is in the second switch position such that the first switchable control signal U is applied to control electrode 114D and the second switchable control signal S is applied to control electrode 114B. The quantum object 205 remains in the electric potential well 200 and moves with the electric potential well toward control electrode 114B when the control switch 116 is in the first switch position and toward control electrode 114D when the control switch 116 is in the second switch position.

As shown in the bottom row of FIG. 2, at time t_{f}, the electrode sequence 130 (as a result of the broadcast control signals applied to the broadcast control electrodes 136 thereof) defines two potential wells 200A, 200B. A first potential well 200A is disposed to the left of the center of the trapping region 110 (e.g., over control electrode 114B) and a second potential well 200B is disposed to the right of the center of the trapping region 110 (e.g., over control electrode 114D). At time t_{f}, the first switchable control signal U is substantially equal to the second switchable control signal S. Thus, which of the first potential well 200A and the second potential well 200B is occupied by the quantum object 205 is dependent on the switch position of the corresponding control switch 116.

For example, the first switchable control signal U(t) is configured to attract the quantum object 205 and the second switchable control signal S(t) is configured to repulse the quantum object 205 (when U≠S), in an example embodiment. Thus, at time t_{f}, the quantum object 205 occupies whichever of the first potential well 200A or second potential well 200B is closer to the switchable control electrode 132, 134 that is in electrical connection with the first switchable control voltage source 5A (and having the first switchable control voltage signal U applied thereto).

Thus, the respective switchable electrical communication between the first switchable control electrode 132 and the second switchable control electrode 134 with the first switchable control voltage source 5A and the second switchable control voltage source 5B enables a conditional motion primitive that can be individually controlled in each of the trapping regions 110 via respective switches 116 even though respective broadcast control electrodes 136 of a plurality of trapping regions are each in electrical communication with the same respective broadcast control voltage sources 10.

Returning to FIG. 1B, in some embodiments, an electrode sequence 130 comprises one or more shim electrodes 118. The shim electrodes 118 are in electrical communication with a set of shim voltage sources 15. In various embodiments, stray fields in the confinement apparatus 100 may cause some motion operations in some trapping regions to be unreliable. To compensate for the stray fields, one or more quasi-static analog voltage signals are applied to one or more shim electrodes 118, in an example embodiment.

Trapping region 110B as illustrated in FIG. 1B illustrates a shim electrode 118 that is in electrical communication with a capacitor 119 that is selectively in electrical communication with a shim voltage source 15 via a shim switch 115. For example, in an example embodiment, the shim electrode voltages may be written by a shim voltage source 15 through a shim switch 115 and stored on a capacitor 119 in electrical communication with the shim electrode 118 upon which the shim voltage source is disconnected from the shim electrode (e.g., the switch is opened), leaving the capacitor 119, which is in constant electrical communication with the shim electrode, to hold the voltage value. Periodically, the shim electrode voltage is refreshed by writing it again by closing the switch to electrically connect the shim voltage source to the shim electrode and associated capacitor storage. In an example embodiment, the shim voltage periodically applied to the shim electrode may be substantially the same or substantially different than the previous value. In this way, the shim voltage value may maintain the necessary value to compensate for stray field drift and overcome slow voltage drift of the capacitor storage due to leakage currents. In another example embodiment, the shim voltage may change to effectuate different operational results. For example, the shim value may be written for gating purposes to a different value than the value used for measurement purposes.

In another example embodiment, a voltage adder is used to insert a quasi-static voltage signal onto one or more of the control electrodes 114. In an example embodiment, a shim electrode 118 is one of the control electrodes 114. As used herein, the term quasi-static refers to an analog signal that changes more slowly in time than the control voltage signals (e.g., U(t), S(t), V₁(t), V₂(t), V₃(t)). For example, the quasi-static voltage signals may have a slower update and/or a lower frequency filter cut-off than the control voltage signals.

In various embodiments, the shim electrode 118 is in switchable electrical communication with one of a first shim voltage source 15A and a second shim voltage source 15B. In various embodiments, the first shim voltage source 15A is configured to generate and provide a first shim voltage signal and the second shim voltage source 15 B is configured to generate and provide a second shim voltage signal. In an example embodiment, the first shim voltage signal and the second shim voltage signal are different voltage signals having different amplitudes and/or signs. In various embodiments, the first shim voltage signal is the same amplitude and the opposite sign of the second shim voltage signal. For example, in an example embodiment, the first shim voltage signal is equal to the second shim voltage signal multiplied by negative one.

In various embodiments, the shim electrode 118 is in switchable electrical communication one of a first shim voltage source 15A and a second shim voltage source 15B via a shim switch 115. In various embodiments, the shim switch 115 is controlled via application of switch signal thereto. In an example embodiment, the switch signal applied to the shim switch 115 is the same as that applied to the control switch 116. For example, the shim switch 115 is in electrical communication with the switch signal generator 20, in an example embodiment.

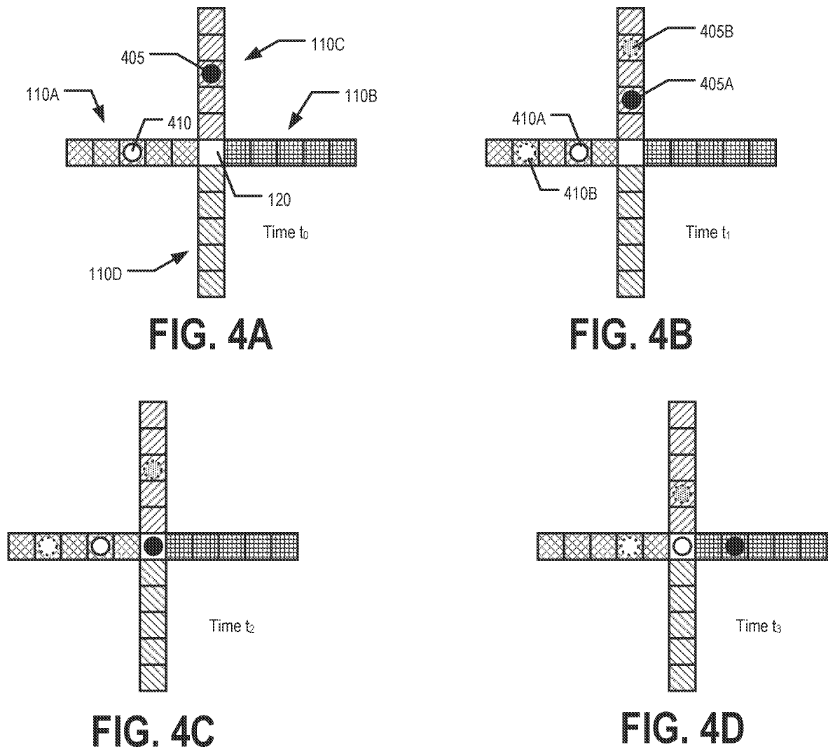

FIG. 3 illustrates another example of the conditional motion primitive that enables the performance of conditional operations in trapping regions in which the switch signal provided to a shim switch 115 and/or a control switch 116 of a trapping region controls whether the quantum object 205 confined by the trapping region is transported from an initial position to a first position or a second position. As should be understood, in various scenarios, one or more quantum objects could be disposed within the potential well 200 and a single quantum object 205 is illustrated in FIG. 3 for clarity.

In the example embodiment illustrated in FIG. 3, the switch signal provided to the switchable control electrodes includes a shim signal. For example, the shim signal may be provided with a first sign (e.g., a negative or positive voltage) to a switchable control electrode 132/134 as part of the first switchable control signal U and the shim signal may be provided with a second sign that is oppose of the first sign (positive or negative voltage) to the other switchable control electrode as part of the second switchable control signal S.

Starting at time t₀, as shown in the top row of FIG. 3, a potential well 200 is generated at an initial position (e.g., the center) of the trapping region 110 due to the control voltage signals (e.g., first and second switchable control voltage signals and broadcast control voltage signals) applied to the control electrodes 114 of the electrode sequence 130. At time t₀, the first switchable control voltage signal is equal to the second switchable control voltage signal and the shim voltage signal (e.g., the voltage signal applied to the shim electrode 118) is at zero.

The middle row of FIG. 3 illustrates the performance of the conditional motion primitive at time t, where t₀<t<t_{f} for the scenario where the corresponding control switch 116 is in a first position (left) and the scenario where the corresponding control switch 116 is in a second position (right). At the intermediate time t between the initial time t₀ and the final time t_{f}, the first switchable control signal U is not equal to the second switchable control signal S. For example, the first switchable control signal U may differ from the second switchable control signal S by two times the absolute amplitude of the shim signal. In particular, a double electric potential well 200C is formed with a first minimum located toward control electrode 114C and a second minimum located toward control electrode 114D. The first minimum and second minimum are separated by a small potential barrier (e.g., small compared to the depth of the potential well 200C). The quantum object 205 occupies the minimum closer to the first switchable control electrode 132 (e.g., control electrode 114B in the example embodiment illustrated in FIG. 3) when, as a result of the control switch 116 being in a first switch position, the first switchable control signal U is applied to the first switchable control electrode 132 and the second switchable control signal S is applied to the second switchable control electrode 134 (e.g., control electrode 114D in the example embodiment illustrated in FIG. 3). Similarly, the quantum object 205 occupies the minimum closer to the second switchable control electrode 134 when, as a result of the control switch 116 being in a second switch position, the first switchable control signal U is applied to the second switchable control electrode 134 and the second switchable control signal S is applied to the first switchable control electrode 132.

As shown in the bottom row of FIG. 3, at time t_{f}, the control voltage signals (e.g., first and second switchable control voltage signals and broadcast control voltage signals) applied to the control electrodes 114 of the electrode sequence 130 cause a first potential well 200A to be located at a first position along the trapping region and a second potential well 200B to be located at a second position along the trapping region and the first switchable control voltage signal U is substantially equal to the second switchable control voltage signal S. For example, by time t_{f}, the amplitude of the shim voltage signal has been ramped back down to zero and the quantum object 205 occupies one of the first potential well 200A or the second potential well 200B based on whether the control switch 116 was in the first switchable position or the second switchable position when the conditional motion primitive was performed.

Thus, in various embodiments, the number of analog voltage sources is proportional to and/or scales with the number of electrodes in the electrode sequences 130 and is not proportional to and/or does not scale with the number of trapping regions 110 of the confinement apparatus 100. Moreover, a single digital signal (e.g., generated by a respective switch signal generator) per trapping region enables independent control over each trapping region such that conditional operations can be caused to be performed in a first subset of trapping regions and prevented from occurring in a second subset of trapping regions.

While FIGS. 2 and 3 illustrate the electrode sequence 130 as being symmetric (e.g., the switchable control electrodes 132, 134 disposed symmetrically about the center of the electrode sequence 130), various embodiments are symmetric in this manner. For example, in an example embodiment, control electrodes 114B and 114E are the switchable control electrodes 132, 134. In another example embodiment, the control electrodes 114 of the electrode sequence 130 may vary in shape and/or size (e.g., length of the control electrode along and/or parallel to the axis 113 or a different dimension of the control electrode). As should be understood, the electrode sequence 130 is illustrated as comprising five control electrodes. However, in various embodiments the electrode sequence 130 may include various numbers of and different sizes and shapes and relative positions of control electrodes.

FIG. 1C illustrates example cyclic path trapping regions 110′n and 100′m. In various embodiments, a cyclic path trapping region is a one-dimensional closed path trapping region. For example, a one-dimensional cyclic path trapping region 110′ may be a circular, elliptical, rectangular, polygonal, or other closed loop trapping region. For example, a plurality of circular, elliptical, rectangular, polygonal, or other closed loop trapping regions 110′ may be used to generate a periodic or quasi-periodic array of trapping regions. In various embodiments, the closed loop of the cyclic path is formed explicitly by the trapping region geometry or formed logically by constructing cyclic paths out of other trapping region geometries (e.g., forming a cyclic path out of a two-dimensional grid of linear trapping regions). The periodic or quasi-periodic array of trapping regions may comprise a combination of cyclic path trapping regions trapping regions 110′ and linear trapping regions 110, in an example embodiment.

In the illustrated embodiment of the circular, elliptical, rectangular, polygonal, or closed loop trapping region 110′, each control electrode 114 (e.g., 114A-114H) is a switchable control electrode. For example, the control switch 116 (e.g., 116n, 116m) controls whether each of the control electrodes 114 are in electrical communication exclusively with the L partition (e.g., V₁^{L}, V₂^{L}, V₃^{L}, V₄^{L}, V₅^{L}, V₆^{L}, V₇^{L}, V₈^{L}, respectively) or the R partition (e.g., V₁^{R}, V₂^{R}, V₃^{R}, V₄^{R}, V₅^{R}, V₆^{R}, V₇^{R}, V₈^{R}, respectively) of the set of switchable control voltage sources 5, with two voltage sources available (i.e., the L channel and the R channel) for each electrode. As should be understood based on the discussion above, the switchable control voltage sources 5 are each configured to be in switchable electrical communication with respective switchable control electrodes of a plurality of trapping regions. For example, the switch position of the switch 116 is controlled by a switch signal s (e.g., sₙ, sₘ) generated and provided by a respective switch signal generator 20. In various embodiments, the switch signal is a digital signal. In various embodiments, when the switch 116 is in a first switch position, it electrically connects the L partition of control voltage sources to the electrode sequence and causes rotation of one or more potential wells of the circular, elliptical, rectangular, polygonal, or other closed loop trapping region 110′ to rotate and/or move counter-clockwise and when the switch 116 is in a second switch position, it electrically connects the R partition of control voltage sources to the electrode sequence and causes rotation of one or more potential wells of the circular, elliptical, rectangular, polygonal, or other closed loop trapping region 110′ to rotate and/or move clockwise. Thus, the switch position of the switch 116 controls whether one or more quantum objects confined by the trapping region 110′ rotate and/or move clockwise or counterclockwise about the circular, elliptical, rectangular, polygonal, or other closed loop trapping region 110′.

In various embodiments, the same control signals are provided to the respective control electrodes 114 of a plurality of electrode sequences 130 which each corresponding to a respective trapping region 110 of a plurality of trapping regions (e.g., of a periodic or quasi-periodic array of trapping regions). The use of shim switch 115 and/or control switch 116 enables individual control of the respective trapping regions 110. For example, the switch position of the shim switch 115 and/or control switch 116 of a respective trapping region determines whether an operation is performed in the respective trapping region or prevented from being performed in the respective trapping region. In other words, the confinement apparatus 100 is configured for conditional performance of parallel operations.

In an example embodiment, different respective positions along respective trapping regions are configured for the performance of various operations thereat. For example, a first position of each respective trapping region of a plurality of trapping regions may be configured for performing a reading operation. For example, a reading manipulation signal path may be aligned with the first position of each respective trapping region of a plurality of trapping regions. Therefore, when a quantum object is located at the first position of a trapping region and a reading operation is performed (e.g., a reading manipulation signal is propagated along the reading manipulation signal path in order to determine the quantum state of the quantum object) the reading operation is performed on the quantum object. When the quantum object is not located at the first position of the trapping region when the reading manipulation signal is propagated along the reading manipulation signal path, performance of the reading operation on the quantum object is prevented.

A second position of each respective trapping region of the plurality of trapping regions may be associated with a conditional operation such as a single qubit gate, a two qubit gate, a qubit initialization operation (e.g., preparing quantum objects into a known state of a defined qubit space), position swapping of quantum objects located within the same trapping region, or another transport or non-transport operation. Using the shim switch 115 or control switch 116 of each respective trapping region of the plurality of trapping regions, whether one or more quantum objects are present at the second position or not can be controlled independently for each respective trapping region. Thus, the conditional operation is performed in a first subset of the plurality of trapping regions and is prevented from being performed (e.g., by an absence of one or more quantum objects at the second position) in a second subset of the plurality of trapping regions. For example, for an example scenario, each of the trapping regions of the plurality of trapping regions where the corresponding shim switch 115 or control switch 116 is in the first switch position is in the first subset of trapping regions and each of the trapping regions of the plurality of trapping regions where the corresponding shim switch 115 or control switch 116 is in the second switch position is the second subset of trapping regions.

In this manner, conditional operations may be performed by the confinement apparatus 100 and/or a quantum system comprising the confinement apparatus 100. In various embodiments, the conditional operations include one or more of a junction swap operation, a linear swap operation, a partial row or column shift, arbitrary quantum object sorting, gating of one or more quantum objects, cooling of quantum objects, measurement of quantum objects, initialization of quantum objects, position swapping of quantum objects located within a same trapping region, or another transport or non-transport operation. For example, the controller 30 may determine to perform an operation on first set of quantum objects that are arbitrarily positioned within the plurality of trapping regions and/or periodic or quasi-periodic array 105 of trapping regions and to prevent performance of the operation on a second set of quantum objects that are arbitrarily positioned within the plurality of trapping regions and/or periodic or quasi-periodic array 105 of trapping regions, even when the quantum system 900 is particularly configured for the parallel performance of operations.

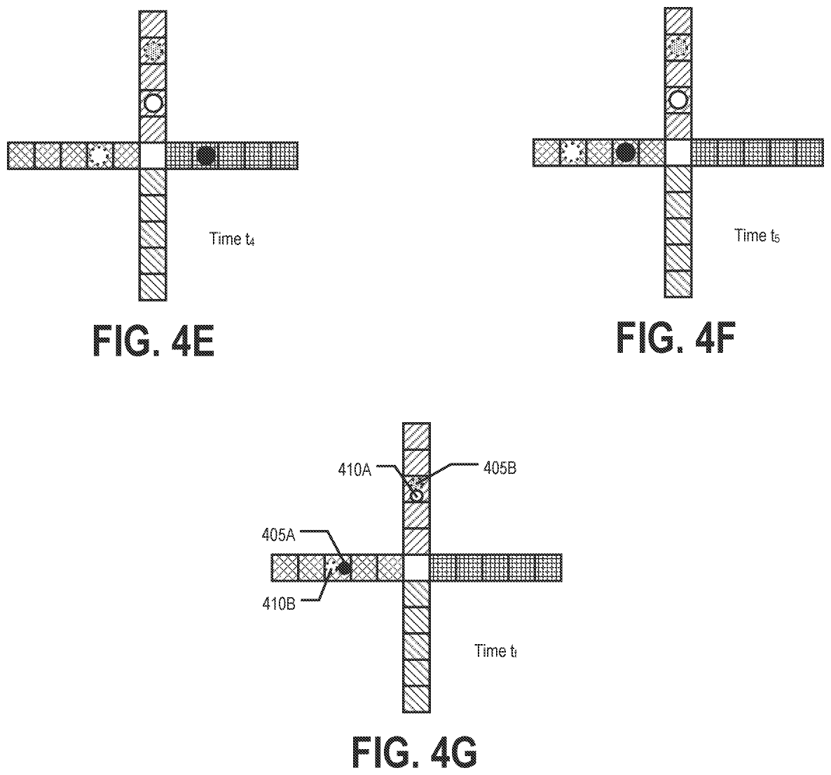

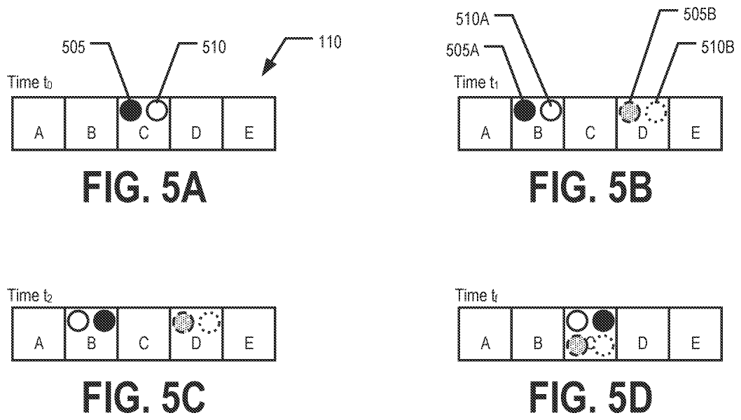

FIGS. 4A-4G and FIGS. 5A-5D provide schematic representations of performance of two example conditional operations that are enabled through the use of the conditional motion primitive illustrated in FIGS. 2 and/or 3, according to example embodiments.

FIGS. 4A-4G provide a schematic representation of the conditional performance of a junction swap operation. For example, as shown by the solid representations of the quantum objects 405, 410 (e.g., 405A, 410A) in FIGS. 4A and 4G, a junction swap operation may be performed to move a first quantum object 405 from one trapping region 110C to another trapping region 110A through junction 120 and move a second quantum object 410 from the trapping region 110A to another trapping region 110C, such that the first and second quantum objects 405, 410 switch positions through the junction 120. As should be understood, each of quantum objects 405, 410 may be one or more quantum objects. As shown by the dashed representations of the quantum objects 405, 410 (e.g., 405B, 410B), use of the conditional motion primitive can prevent the quantum objects 405, 410 from changing positions or cause the quantum objects 405, 410 to be brought together in either of the trapping regions 110A, 110C.

Starting at FIG. 4A, a portion of a plurality of trapping regions and/or periodic or quasi-periodic array 105 of trapping regions 110 is shown at an initial time t₀. The portion of the plurality of trapping regions and/or periodic or quasi-periodic array includes trapping regions 110A, 110B, 110C, 110D connected by junction 120. A first quantum object 405 is located at an initial position (e.g., the center of) the third trapping region 110C and a second quantum object 410 is located at an initial position (e.g., the center of) the first trapping region 110A.

FIG. 4B illustrates the portion of the plurality of trapping regions and/or periodic or quasi-periodic array at a first time t₁. Between the initial time t₀ and the first time t₁, the conditional motion primitive has been performed. For example, in a scenario where the first quantum object 405 is to be moved from the third trapping region 110C to the first trapping region 110A, the first quantum object 405 is moved from the initial position in the third trapping region 110C to a first position in the third trapping region, as shown by the solid representation of the first quantum object 405A. In a scenario where the first quantum object 405 is not to be moved from the third trapping region 110C to the first trapping region 110A, the first quantum object 405 is moved from the initial position in the third trapping region 110C to a second position in the third trapping region, as shown by the dashed representation of the first quantum object 405B. Whether the first quantum object 405 is moved from the initial position to the first position or second position of the third trapping region 110C is controlled through the switch position of the shim switch 115 or the control switch 116 corresponding to the third trapping region 110C.

Similarly, during performance of the conditional motion primitive in a scenario where the second quantum object 410 is to be moved from the first trapping region 110A to the third trapping region 110C, the second quantum object 410 is moved from the initial position in the first trapping region 110A to a first position in the first trapping region, as shown by the solid representation of second quantum object 410A. In a scenario where the second quantum object 410 is not to be moved from the first trapping region 110A to the third trapping region 110C, the second quantum object 410 is moved from the initial position in the first trapping region 110A to a second position in the first trapping region, as shown by the dashed representation of the second quantum object 410B. Whether the second quantum object 410 is moved from the initial position to the first position or second position of the first trapping region 110A is controlled through the switch position of the shim switch 115 or the control switch 116 corresponding to the first trapping region 110A.

FIG. 4C illustrates the portion of the plurality of trapping regions and/or periodic or quasi-periodic array of trapping regions at a second time t₂. Between the first time t₁ and a second time t₂, a downward shift has been performed in the vertical group of trapping regions (including trapping regions 110C, 110D). For example, the control voltage signals applied to the control electrodes 114 of the electrode sequences 130 corresponding to the vertical group of trapping regions has caused all of the quantum objects located in trapping regions of the vertical group of trapping regions to move downward along the respective trapping regions (and possibly through junction 120).

FIG. 4D illustrates the portion of the plurality of trapping regions and/or periodic or quasi-periodic array of trapping regions at a third time t₃. Between the second time t₂ and the third time t₃, a rightward shift has been performed in the horizontal group trapping regions (including trapping regions 110A, 110B). For example, the control voltage signals applied to the control electrodes 114 of the electrode sequences 130 corresponding to the horizontal group of trapping regions has caused all of the quantum objects located in trapping regions of the horizontal group of trapping regions to move rightward along the respective trapping regions (and possibly through junction 120).

FIG. 4E illustrates the portion of the plurality of trapping regions and/or periodic or quasi-periodic array of trapping regions at a fourth time t₄. Between the third time t₃ and the fourth time t₄, an upward shift has been performed in the vertical group of trapping regions (including trapping regions 110C, 110D). For example, the control voltage signals applied to the control electrodes 114 of the electrode sequences 130 corresponding to the vertical group of trapping regions has caused all of the quantum objects located in trapping regions of the vertical group of trapping regions to move upward along the respective trapping regions (and possibly through junction 120).

FIG. 4F illustrates the portion of the plurality of trapping regions and/or periodic or quasi-periodic array of trapping regions at a fifth time t₅. Between the fourth time t₄ and the fifth time t₅, a leftward shift has been performed in the horizontal group trapping regions (including trapping regions 110A, 110B). For example, the control voltage signals applied to the control electrodes 114 of the electrode sequences 130 corresponding to the horizontal group of trapping regions has caused all of the quantum objects located in trapping regions of the horizontal group of trapping regions to move leftward along the respective trapping regions (and possibly through junction 120).

FIG. 4G illustrates the portion of the plurality of trapping regions and/or periodic or quasi-periodic array of trapping regions at a final time t_{f} corresponding to the completion of the conditional junction swap operation. Between the fifth time t₅ and the final time t_{f}, an inverse conditional motion primitive is performed. The inverse conditional motion primitive is the opposite motion primitive of the conditional motion primitive performed between the initial time to and the first time t₁. For example, the inverse conditional motion primitive is performed by reversing the time order of the steps shown in FIGS. 2 and/or 3. For example, performance of the inverse conditional motion primitive causes the any quantum objects 405, 410 located at the second position or first position of the first trapping region 110A to be moved to the initial position of the first trapping region 110A and any quantum objects 405, 410 located at the second position or first position of the third trapping region 110C to be moved to the initial position of the third trapping region 110C.

Depending on the switch position of the shim switch 115 and/or control switch 116 of the first trapping region 110A during the conditional motion primitive between the initial time t₀ and the first time t₁, the second quantum object 410 is either located at the initial position of the third trapping region 110C (as indicated by the solid representation of the second quantum object 410A) or located at the initial position of the first trapping region 110A (as indicated by the dashed representation of the second quantum object 410B) at the final time t_{f}. Depending on the switch position of the shim switch 115 and/or control switch 116 of the third trapping region 110C during the conditional motion primitive between the initial time t₀ and the first time t₁, the first quantum object 405 is either located at the initial position of the first trapping region 110A (as indicated by the solid representation of the first quantum object 405A) or located at the initial position of the third trapping region 110C (as indicated by the dashed representation of the first quantum object 405B) at the final time t_{f}.

Thus, whether or not an operation is performed or prevented from being performed in a respective trapping region is controlled through the switch position (as controlled by the respective switch signal) of a shim switch 115 or control switch 116 of the respective trapping region during the performance of a conditional motion primitive.

FIGS. 5A-5D provide a schematic representation of the conditional performance of a linear swap operation. For example, as shown by the solid representations of the quantum objects 505, 510 (e.g., 505A, 510A) in FIGS. 5A and 5D, a linear swap operation may be conditionally performed to swap the order of a first quantum object 505 and a second quantum object 510 within a trapping region 110. As shown by the dashed representations of the quantum objects 505, 510 (e.g., 505B, 510B), use of the conditional motion primitive can prevent the quantum objects 505, 510 from swapping order in the trapping region 110. As should be understood, each of quantum objects 505, 510 may be one or more quantum objects 505, 510.

FIG. 5A illustrates a pair of quantum objects 505, 510 in a trapping region 110 at an initial time t₀. At the initial time t₀, a first quantum object 505 and a second quantum object 510 are disposed in a first order at an initial position of the trapping region 110.

FIG. 5B illustrates the pair of quantum objects 505, 510 at a first time t₁. Between the initial time t₀ and the first time t₁, the conditional motion primitive has been performed. For example, in a scenario where the order of the first quantum object 505 and the second quantum object 510 are to be swapped, the first quantum object 505 and the second quantum object 510 are moved from the initial position in the trapping region 110 to a first position in the trapping region, as shown by the solid representation of the first quantum object 505A and the second quantum object 510A. In a scenario where the order of the first quantum object 505 and the second quantum object is not to be swapped, the first quantum object 505 and the second quantum object 510 are moved from the initial position in the trapping region 110C to a second position in the trapping region, as shown by the dashed representation of the first quantum object 505B and the second quantum object 510B. Whether the first quantum object 505 and the second quantum object 510 are moved from the initial position to the first position or second position of the trapping region 110 is controlled through the switch position of the shim switch 115 or the control switch 116 corresponding to the trapping region 110.

FIG. 5C illustrates the pair of quantum objects 505, 510 at a second time t₂. Between the first time t₁ and the second time t₂, a swap operation is performed at the first position of the trapping region 110. For example, as shown by the solid representation of the first quantum object 505A and the second quantum object 510A, the order of the first quantum object 505A and the second quantum object 510A have been swapped. For example, by the second time t₂, the first quantum object 505A and the second quantum object 510A have been swapped from a first order to a second order. As shown by the dashed representation of the first quantum object 505B and the second quantum object 510B, the order of the first quantum object 505B and the second quantum object 510B has not been swapped. In particular, the swap operation occurred at the first position of the trapping region 110. Thus, when the first quantum object 505B and the second quantum object 510B are disposed at the second position of the trapping region 110, performance of the swapping operation is prevented.

FIG. 5D illustrates the pair of quantum objects 505, 510 at a final time t_{f} corresponding to the completion of the conditional linear swap operation. Between the second time t₂ and the final time t_{f}, an inverse conditional motion primitive is performed. The inverse conditional motion primitive is the opposite motion primitive of the conditional motion primitive performed between the initial time t₀ and the first time t₁. For example, the inverse conditional motion primitive is performed by reversing the time order of the steps shown in FIGS. 2 and/or 3. For example, performance of the inverse conditional motion primitive causes the first and second quantum objects 505, 510 located at the second position or first position of the trapping region 110 to be moved back to the initial position of the trapping region 110.

Depending on the switch position of the shim switch 115 and/or control switch 116 of the trapping region 110 during the conditional motion primitive between the initial time t₀ and the first time t₁, the first quantum object 505 and the second quantum object 510 are either located at the initial position of the trapping region 110 (as indicated by the solid representation of the first quantum object 505A and the second quantum object 510A) in a first order or located at the initial position of the trapping region 110 (as indicated by the dashed representation of the first quantum object 505B and second quantum object 510B) in a second order at the final time t_{f}.

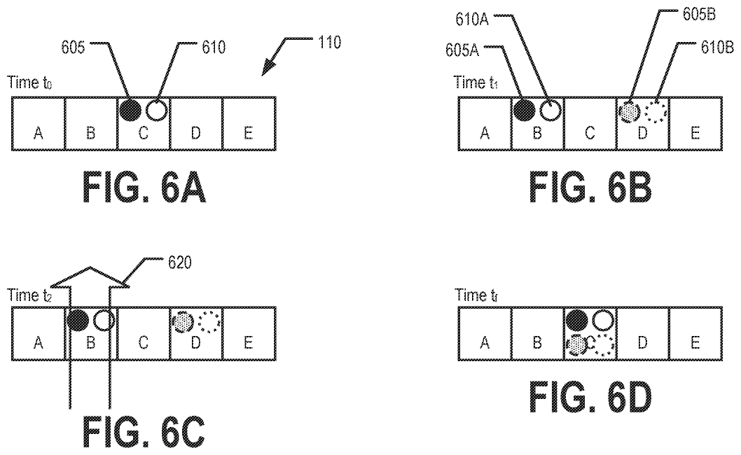

FIGS. 6A-6D provide a schematic representation of the conditional performance of a conditional non-transport operation. A non-transport operation includes the interaction of one or more qubits with a field such as an electromagnetic field (e.g., laser and/or microwave beams or pulses), magnetic fields, magnetic field gradients, electric field, or another field. For example, a non-transport operation may include the interaction of one or more qubits with a manipulation signal. Some non-limiting examples of non-transport operations include a single qubit quantum gate, two or more-qubit quantum gate, quantum initialization operation, quantum measurement operation (i.e., reading operation), cooling operation, load operation, quantum object ejection (e.g., causing the quantum object to no longer be trapped by the confinement apparatus 100), or other operation that includes interaction of one or more qubits with a field.

For example, as shown by the solid representations of the quantum objects 605, 610 (e.g., 605A, 610A) in FIGS. 6A and 6D, a non-transport operation may be conditionally performed to cause interaction of a first quantum object 605 and, possibly, a second quantum object 610 with a field within a trapping region 110. As should be understood, each of quantum objects 605, 610 maybe one or more quantum objects. As shown by the dashed representations of the quantum objects 605, 610 (e.g., 605B, 610B), use of the conditional motion primitive can prevent the quantum objects 605, 610 from performing the non-transport operation in the trapping region 110. For example, the interaction of the first quantum object 605 and, possibly, the second quantum object 610 may be prevented.

While FIGS. 6A-6D illustrate the conditional non-transport operation being performed on two qubits (e.g., first quantum object 605 and second quantum object 610), in various embodiments the conditional non-transport operation may be performed on a single qubit (e.g., just the first quantum object 605) or on more than two qubits by transporting additional qubits to the initial position of the trapping region 110 prior to the initial time t₀ or removing a quantum object (e.g., the second quantum object 610 from the initial position of the trapping region prior to the initial time t₀.

FIG. 6A illustrates a pair of quantum objects 605, 610 in a trapping region 110 at an initial time t₀. At the initial time t₀, a first quantum object 605 and a second quantum object 610 are disposed in a first order at an initial position of the trapping region 110.

FIG. 6B illustrates the pair of quantum objects 605, 610 at a first time t₁. Between the initial time t₀ and the first time t₁, the conditional motion primitive has been performed. For example, in a scenario where the non-transport operation is to be performed on the first quantum object 605 and the second quantum object 610, the first quantum object 605 and the second quantum object 610 are moved from the initial position in the trapping region 110 to a first position in the trapping region, as shown by the solid representation of the first quantum object 605A and the second quantum object 610A. In a scenario where the non-transport operation is not to be performed on the first quantum object 605 and the second quantum object 610, the first quantum object 605 and the second quantum object 610 are moved from the initial position in the trapping region 110C to a second position in the trapping region, as shown by the dashed representation of the first quantum object 605B and the second quantum object 610B. Whether the first quantum object 605 and the second quantum object 610 are moved from the initial position to the first position or second position of the trapping region 110 is controlled through the switch position of the shim switch 115 or the control switch 116 corresponding to the trapping region 110.

FIG. 6C illustrates the pair of quantum objects 605, 610 at a second time t₂. At the second time t₂, a field 620 (one or more manipulation signals such as laser beams or pulses, magnetic fields, magnetic field gradients, microwaves beams or pulses, electrical fields, and/or the like) is substantially applied to the first position of the trapping region 110 (e.g., position B in FIG. 6C) and is not substantially applied to the second position of the trapping region 110 (e.g., position D in FIG. 6C). For example, as shown by the solid representation of the first quantum object 605A and the second quantum object 610A, the field 620 is incident on the first quantum object 605A and the second quantum object 610A and/or the first quantum object 605A and the second quantum object 610A substantially experience the field 620. For example, at the second time t₂, the first quantum object 605A and the second quantum object 610A interact with the field 620 which results in the non-transport operation being performed. As shown by the dashed representation of the first quantum object 605B and the second quantum object 610B, the first quantum object 605B and the second quantum object 610B do not substantially interact with the field 620. As used herein, when the first and second quantum objects 605B, 610B do not substantially experience or do not substantially interact with the field 620, any interaction of the first and second quantum objects 605B, 610B with the field 620 is not sufficient to mediate, cause, or drive the non-transport operation that the field 620 is intended to mediate, cause, or drive (at the first position). In particular, the non-transport operation occurred at the first position of the trapping region 110. Thus, when the first quantum object 605B and the second quantum object 610B are disposed at the second position of the trapping region 110, performance of the non-transport operation (e.g., via interaction with the field 620) is prevented.

FIG. 6D illustrates the pair of quantum objects 605, 610 at a final time t_{f} corresponding to the completion of the conditional non-transport operation. Between the second time t₂ and the final time t_{f}, an inverse conditional motion primitive is performed. The inverse conditional motion primitive is the opposite motion primitive of the conditional motion primitive performed between the initial time t₀ and the first time t₁. For example, the inverse conditional motion primitive is performed by reversing the time order of the steps shown in FIGS. 2 and/or 3. For example, performance of the inverse conditional motion primitive causes the first and second quantum objects 605, 610 located at the second position or first position of the trapping region 110 to be moved back to the initial position of the trapping region 110.

Depending on the switch position of the shim switch 115 and/or control switch 116 of the trapping region 110 during the conditional motion primitive between the initial time t₀ and the first time t₁, the first quantum object 605 and the second quantum object 610 are either located at the initial position of the trapping region 110 (as indicated by the solid representation of the first quantum object 605A and the second quantum object 610A) having interacted with the field 620 (and thus having the non-transport operation performed thereon) or located at the initial position of the trapping region 110 (as indicated by the dashed representation of the first quantum object 605B and second quantum object 610B) without having substantially interacted with the field 620 (and thus not having the non-transport operation performed thereon) at the final time t_{f}.

Another example of a conditional operation is a partial row or column shift. In various embodiments, partial row or column shifts may be used to load the periodic or quasi-periodic array 105 with quantum objects and/or to replace missing quantum objects. For example, trapping regions 110A and 110B are part of a row of trapping regions and trapping regions 110C and 110D are part of a column of trapping regions, in an example embodiment. For example, it may be determined that one or more quantum objects are missing from a particular trapping region 110 of the confinement apparatus 100. For example, during the performance of a quantum circuit and/or algorithm, it may be determined that a trapping region 110 that the controller 30 expected was occupied by one or more quantum objects does not currently contain each of the one or more quantum objects. In order to continue performing the quantum circuit and/or algorithm, the controller 30 my determine to fill the empty trapping region and/or replace the missing one or more quantum objects by shifting the quantum objects in a corresponding row or column such that the empty trapping region is no longer empty and/or the missing one or more quantum objects are replaced. For example, the controller 30 determines that a first set of quantum objects should be shifted along a corresponding row or column of trapping regions to cause the empty trapping region to no longer be empty. The conditional motion primitive may be used to cause the first set of quantum objects, which were respectively disposed in respective trapping regions of a first subset of trapping regions, to be shifted over while other quantum objects (which are respectively disposed in respective trapping regions of a second subset of trapping regions) are not shifted.

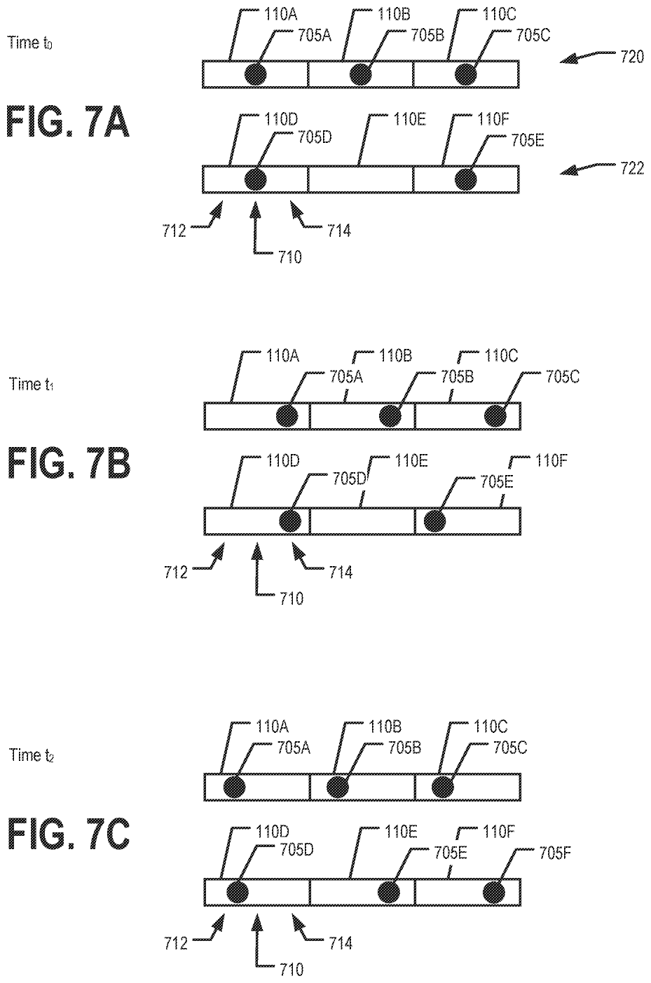

FIGS. 7A-7D provide a schematic representation of the conditional performance of a partial row shift. As should be understood, a partial column shift may be performed similar to the example embodiment illustrated in FIGS. 7A-7D, but with columns of trapping regions 110 rather than the illustrated rows of trapping regions.

FIG. 7A illustrates a first quantum object 705A disposed at an initial position 710 of a first trapping region 110A, a second quantum object 705B disposed at an initial position of a second trapping region 110B, and a third quantum object 705C disposed at an initial position of a third trapping region 110C. As should be understood, each of the quantum objects 705 may be one or more quantum objects. The first, second, and third trapping regions 110A, 110B, 110C form a first row 720 of trapping regions. A second row 722 of trapping regions 110 includes fourth, fifth, and sixth trapping regions 110D, 110E, 110F. A fourth quantum object 705D is disposed at an initial position 710 of the fourth trapping region 110D and a fifth quantum object 705E is disposed at an initial position of the sixth trapping region 110F. No quantum objects are disposed within the fourth trapping region 110D at the initial time t₀.

In the example illustrated scenario, performance of the quantum circuit requires each of the first, second, third, fourth, fifth, and sixth trapping regions 110 to be occupied by respective quantum objects 705. As the first row 720 of trapping regions is already fully occupied (e.g., the first quantum object 705A occupies the first trapping region 110A, the second quantum object 705B occupies the second trapping region 110B, and the third quantum object 705C occupies the third trapping region 110C) no changes are required to the first, second, and third trapping regions. Similarly, as the fourth trapping region 110D is occupied by the fourth quantum object 705D, no changes are required to the fourth trapping region. However, as each of the trapping regions 110A, 110B, 110C, 110D, 110E, 110F have a common structure and comprise control electrodes 114 in communication with common broadcast control voltage sources and switchable control voltage sources (e.g., common among the trapping regions), the transport operations used to cause the fifth trapping region 110E to be occupied will affect the first, second, third, and fourth trapping regions.

FIG. 7B illustrates the first row 710 and second row 722 of trapping regions at a first time t₁. Between the initial time t₀ and the first time t₁, the conditional motion primitive has been performed in each of the illustrated trapping regions. The conditional motion primitive is a transport operation configured to move or transport a quantum object disposed at an initial position 710 of a respective trapping region 110 to either a first position 712 or a second position 714 of the respective trapping region 110 based on the switch position of a respective shim switch 115 and/or control switch 116 corresponding to the respective trapping region 110. For example, for trapping regions in which no change is desired or necessary, the performance of the conditional motion primitive causes the respective quantum object 705 to be transported to a respective second position 714 of the respective trapping region 110. As the fifth quantum object 705E currently disposed in the sixth trapping region 110F is to be shifted to the fifth trapping region 110E, the performance of the conditional motion primitive causes the fifth quantum object 705E to be transported to the first position 712 of the sixth trapping region 11 OF.

Whether a respective quantum object 705 is moved or transported from the respective initial position 710 to the respective first position 712 or respective second position 714 of the respective trapping region 110 is controlled through the switch position of the respective shim switch 115 or the respective control switch 116 corresponding to the respective trapping region 110.

FIG. 7C illustrates the first row 720 and the second row 722 of trapping regions 110 at a second time t₂. Between the first time t₁ and the second time t₂, all of the quantum objects 705 have been shifted to the left. For example, the first, second, third, and fourth quantum objects 705A, 705B, 705C, 705D have been shifted from the respective second position 714 of the respective trapping regions 110A, 110B, 110C, 110D to the respective first position 712 of the respective trapping regions. The fifth quantum object 705E has been shifted from the first position 712 of the sixth trapping region 110F to the second position 714 of the fifth trapping region 110E. Additionally, a sixth quantum object 705F has been loaded and/or shifted into the sixth trapping region 110F (e.g., from another trapping region not shown and/or from a loading portion of the confinement apparatus 100).

FIG. 7D illustrates the first row 720 and the second row 722 of trapping regions 110 at a final time t_{f} corresponding to the completion of the partial row shift operation. Between the second time t₂ and the final time t_{f}, an inverse conditional motion primitive is performed in each of the illustrated trapping regions. The inverse conditional motion primitive is a transport operation configured to move or transport a quantum object disposed at either a first position 712 or a second position 714 of a respective trapping region 110 to an initial position 710 of a respective trapping region 110, based on the switch position of a respective shim switch 115 and/or control switch 116 corresponding to the respective trapping region 110. The inverse conditional motion primitive is the opposite motion primitive of the conditional motion primitive performed between the initial time t₀ and the first time t₁. For example, the inverse conditional motion primitive is performed by reversing the time order of the steps shown in FIGS. 2 and/or 3. For example, performance of the inverse conditional motion primitive causes the first, second, third, and fourth quantum objects 705A, 705B, 705C, 705D to be moved or transported from respective first positions 712 of the respective trapping regions 110A, 110B, 110C, 110D to respective initial positions 710 of the respective trapping regions between times t₂ and t_{f}. For example, performance of the inverse conditional motion primitive causes the fifth and sixth quantum objects 705E, 705F to be moved or transported from respective second positions 714 of the respective trapping regions 110E, 110F to respective initial positions 710 of the respective trapping regions between times t₂ and t_{f}. Thus, at time t_{f}, each of the first, second, third, fourth, fifth, and sixth trapping regions 110A, 110B, 110C, 110D, 110E, 110F are occupied with respective quantum objects 110A, 110B, 110C, 110D, 110E, 110F disposed at the respective initial positions 710 of the respective trapping regions 110.

It should be understood that FIGS. 7A-7D illustrate an example embodiment of a conditional row shift operation where no junctions between trapping regions are illustrated. Example embodiments where junctions, both two-dimensional and three-dimensional, are disposed between trapping regions of a two-dimensional and/or three-dimensional quantum object confinement apparatus are similar and contemplated. For example, based on the disclosure provided herein, one of ordinary skill in the art would be able to perform conditional column shift operations and/or conditional shift operations through various junctions of the confinement apparatus.

Thus, whether or not an operation is performed or prevented from being performed in a respective trapping region is controlled through the switch position (as controlled by the respective switch signal) of a respective shim switch 115 or control switch 116 of the respective trapping region during the performance of a conditional motion primitive.

Additionally, the use of the inverse conditional motion primitive allows and/or enables repeated applications of the conditional motion primitive followed by the inverse conditional motion primitive to maintain a bounded numbers of potential wells (e.g., for confining quantum objects) and/or keeping the system size finite even while supporting arbitrarily long operational counts.

As noted above, various embodiments provide and/or provide methods for use with various confinement apparatuses. For example, the confinement apparatus may be an optical trap, magnetic trap, dipole trap, quadrupole trap, and/or the like comprising a plurality of trapping regions of similar and/or a common structure. In various embodiments, confinement control field sources provide switchable, broadcast, and/or shim control signals that are used to generate and/or provide respective confinement potentials that are used to perform conditional motion primitives and inverse conditional motion primitives. The conditional motion primitives and inverse conditional motion primitives enable the use of broadcast control signals to a plurality of trapping regions of similar and/or common structure while enabling independent control over whether or not a conditional operation is performed in each of the plurality of trapping regions.

For example, the control voltage signals are an example of control signals generated by respective confinement control field sources. The control voltage sources are one example of confinement control field sources. Some other examples of confinement control field sources include lasers and corresponding optical systems for providing one or more laser beams used to generate trapping laser fields, electric current sources for providing electric currents for generating electric and/or magnetic confinement potentials, and magnetic field sources for providing magnetic fields or magnetic field gradients used to form magnetic confining potentials. For example, in various embodiments, the control signals include broadcast control signals (such as the broadcast control voltage signals), switchable control signals (such as the switchable control voltage signals), and/or shim control signals (such the shim voltage signals). The used to control the confinement field of the respective confinement apparatus.

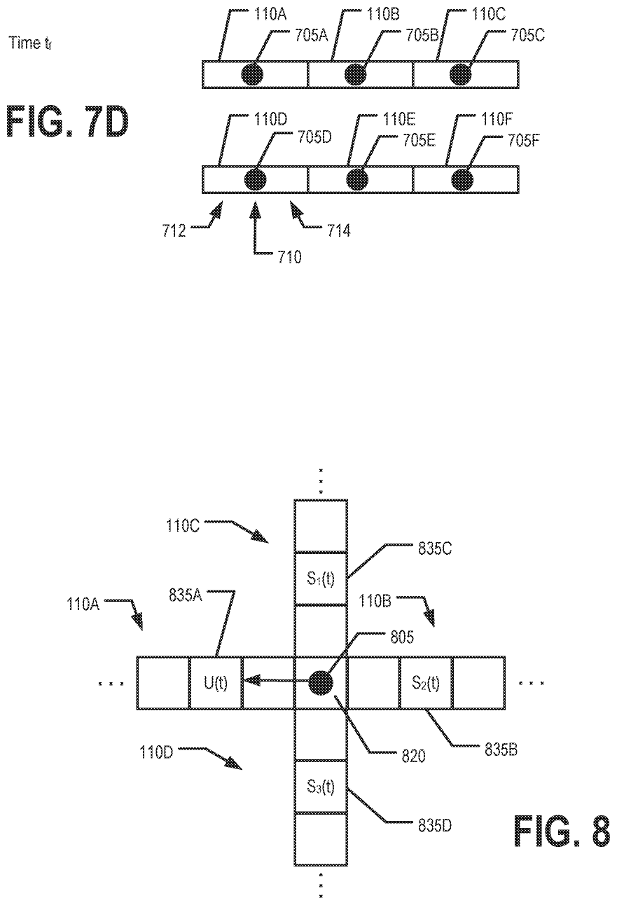

FIGS. 4A-4G, 5A-5D, 6A-6D, and 7A-7D illustrates example conditional operations that are performed where the quantum objects are, in the initial steps (e.g., see FIGS. 4A, 5A, 6A, and 7A) and final steps (e.g., see FIGS. 4G, 5D, 6D, and 7D) of the respective conditional operations, located at respective positions along linear and/or one-dimensional trapping regions. FIG. 8 illustrates an example conditional operation where the quantum object 805 is located at a junction 820 between a set of linear and/or one-dimensional trapping regions 110A, 110n, 110C, 110D.

For example, the conditional operation may include transporting the quantum object from the junction 805 to a location along a selected one of the trapping regions of the set of linear and/or one-dimensional trapping regions 110A, 110B, 110C, 110D. For example, respective control switches 116 are used to selectively couple one or more switchable control electrodes 835 (e.g., 835A, 835n, 835C, 835D) to switchable control voltage source 5A, 5B so that the quantum object 805 is transported to the selected one of the trapping regions of the set of linear and/or one-dimensional trapping regions.

In the example illustrated in FIG. 8, the conditional motion primitive is used to transport the quantum object 805 from the junction 820 to a location along the first trapping region 110A. For example, the switchable control electrode 835A of the first trapping region 110A is placed into communication (e.g., via a respective control switch 116) with the first switchable control voltage source 5A such that a first switchable control signal U(t) that is configured to attract the quantum object 805 is applied to the switchable control electrode 835A of the first trapping region 110A. The switchable control electrodes 835B, 835C, 835D of the second, third, and fourth trapping regions 110B, 110C, 110D are placed into communication (e.g., via respective control switches 116) with one or more second switchable control voltage sources 5B such that respective second switchable control signals S₁(t), S₂(t), S₃(t) that are configured to repulse the quantum object 805 are applied to the respective switchable control electrodes 835B, 835C, 835D of the second, third, and fourth trapping regions 110B, 110C, 110D. In the illustrated embodiment, the quantum object is transported from the junction 820 to the left to the first trapping region 110A by the conditional operation. In a scenarios where the quantum object is transported from the junction 820 up into the third trapping region 110C, the respective voltage signals applied to the switchable control electrodes 835A, 835B, 835C, 835D would be rotated a quarter turn clockwise (e.g., U(t) would be applied to switchable control electrode 835C, S₁(t) would be applied to switchable control electrode 835B, S₂(t) would be applied to switchable control electrode 835D, and S₃(t) would be applied to switchable control electrode 835A). Similarly, the controller 30 may control the application of respective voltage signals to the switchable control electrodes 835A, 835B, 835C, 835D to cause the quantum object to be transported from the junction 820 to the second trapping region 110B or the fourth trapping region 110D, as appropriate for the application.

In an example embodiment, two or more of the respective second switchable control signals S₁(t), S₂(t), S₃(t) are equal to one another and/or generated by the same second switchable control voltage source 5B. In an example embodiment, the respective second switchable control signals S₁(t), S₂(t), S₃(t) are different from one another and/or generated by different second switchable control voltage sources 5B. In various embodiments, the junction 820 may link and/or enable a quantum object 805 to be transported between two or more trapping regions 110. For a junction 820 linking n trapping regions 110, respective switchable voltage signals U(t), S₁(t), . . . Sₙ₋₁(t) are applied to respective switchable control electrodes 835 to cause performance of the conditional motion primitive.

As should be understood, the performance of the conditional operation may finish with the quantum object 805 disposed at the junction 820 (or another junction) or at a location along a selected linear and/or one-dimensional trapping region, as appropriate for the application. As should be understood, the junction 820 may be one of a plurality of junctions of the quantum object confinement apparatus 100. Quantum objects may be disposed, at various points before, during, and/or after performance of conditional operations at selected junctions of the plurality of junctions, as appropriate for the application.

### Example Quantum System Comprising a Quantum Object Confinement Apparatus

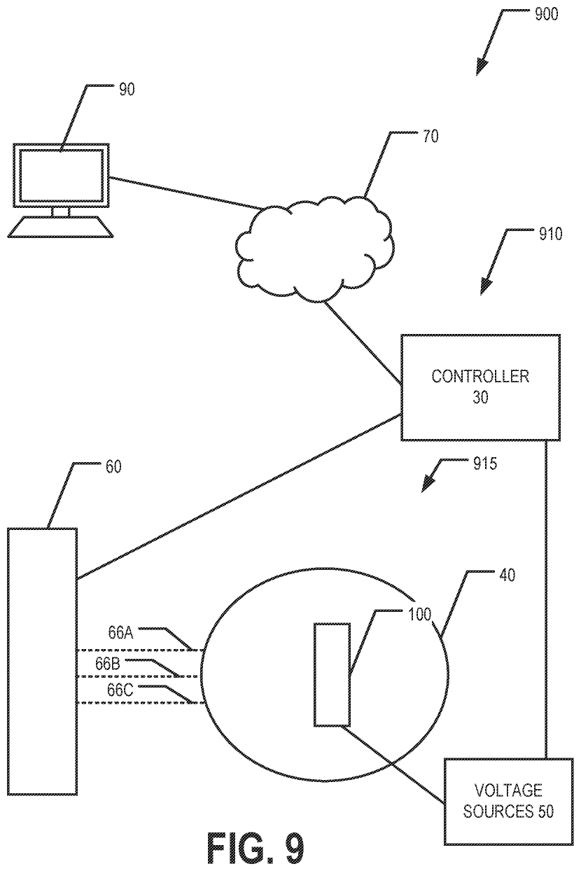

As described above, the performance of conditional operations may be performed on one or more quantum objects confined within trapping regions of a quantum object confinement apparatus is controlled by a controller 30 of a quantum computer 910, in various embodiments. FIG. 9 provides a schematic diagram of an example quantum system 900 comprising quantum object confinement apparatus 100 (e.g., ion trap, optical trap, and/or the like), in accordance with an example embodiment. In various embodiments, the quantum system 900 comprises a computing entity 90 and a quantum computer 910. In various embodiments, the quantum computer 910 comprises a controller 30 and a quantum processor 915. In various embodiments, the quantum processor 915 comprises a quantum object confinement apparatus 100 enclosed in a cryostat and/or vacuum chamber 40, one or more voltage sources 50, one or more manipulation sources 60, and/or the like.

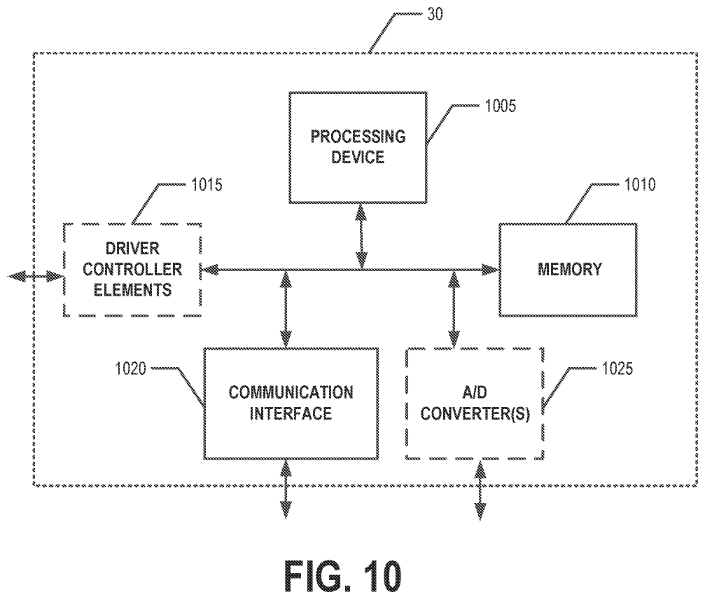

In an example embodiment, the one or more manipulation sources 60 comprise one or more lasers (e.g., optical lasers, microwave sources, and/or the like). In various embodiments, the one or more manipulation sources 60 are configured to manipulate and/or cause a controlled quantum state evolution of one or more quantum objects within the quantum object confinement apparatus 100. For example, in an example embodiment, wherein the one or more manipulation sources 60 comprise one or more lasers, the lasers may provide one or more laser beams to the confinement apparatus within the cryogenic and/or vacuum chamber 40. The laser beams may be used to perform one or more conditional operations such as the conditional performance of quantum gates, sympathetic cooling, and/or the like. In various embodiments, the manipulation sources 60 are controlled by respective driver controller elements 1015 of the controller 30 (see FIG. 10).

In various embodiments, the quantum computer 910 comprises one or more voltage sources 50. For example, the voltage sources 50 comprise the control voltage sources (e.g., switchable control voltage sources 5A, 5B, broadcast control voltage sources 10A, 10B, 10C), switch signal generators 20 (e.g., 20A, 20B), shim voltage sources 15 (e.g., 15A, 15B), at least one RF driver and/or voltage source configured to generate and provide an RF voltage signal the RF rails 112, and/or the like. The voltage sources 50 are electrically coupled to the corresponding elements (e.g., control electrodes 114, shim switches 115 and/or control switches 116, RF rails 112) of the quantum object confinement apparatus 100, in an example embodiment. For example, the voltage sources 50 are configured to provide periodic voltage signals to the RF rails 112 and control voltage signals to the control electrodes 114. In various embodiments, the switch signal generators 20 are each in communication with a respective switch (e.g., shim switch 115 and/or control switch 116) configured to control the conditional performance (and/or prevention thereof) in a respective trapping region of the plurality of trapping regions and/or periodic or quasi-periodic array 105 of trapping regions 110 of the confinement apparatus 100. In various embodiments, the voltages sources 50 are controlled by respective driver controller elements 1015 of the controller 30.

In various embodiments, a computing entity 90 is configured to allow a user to provide input to the quantum computer 910 (e.g., via a user interface of the computing entity 90) and receive, view, and/or the like output from the quantum computer 910. The computing entity 90 may be in communication with the controller 30 of the quantum computer 910 via one or more wired or wireless networks 70 and/or via direct wired and/or wireless communications. In an example embodiment, the computing entity 90 may translate, configure, format, and/or the like information/data, quantum circuits, quantum computing algorithms, and/or the like into a computing language, executable instructions, command sets, and/or the like that the controller 30 can understand and/or implement.

In various embodiments, the controller 30 is configured to control the voltage sources 50, cryogenic system and/or vacuum system controlling the temperature and pressure within the cryogenic and/or vacuum chamber 40, manipulation sources 60, and/or other systems controlling various environmental conditions (e.g., temperature, pressure, and/or the like) within the cryogenic and/or vacuum chamber 40 and/or configured to manipulate and/or cause a controlled evolution of quantum states of one or more quantum objects within the confinement apparatus 100. For example, the controller 30 may cause a controlled evolution of quantum states of one or more quantum objects within the confinement apparatus to execute a quantum circuit and/or algorithm. In various embodiments, the quantum objects confined within the confinement apparatus 100 are used as qubits of the quantum computer 910. In an example embodiment, the quantum processor 915 includes a plurality of multi-quantum object crystals that each comprise a first quantum object used as a qubit quantum object of the quantum processor and a second quantum object used as a sympathetic cooling quantum object for use in cooling the qubit quantum object of the same multi-quantum object crystal.

### Example Controller

In various embodiments, a quantum object confinement apparatus 100 comprising a plurality of trapping regions and/or periodic or quasi-periodic array 105 of one-dimensional trapping regions 110 is incorporated into a quantum computer 910. In various embodiments, a quantum computer 910 further comprises a controller 30 configured to control various elements of the quantum computer 910. For example, the controller 30 may be configured to control the voltage sources 50, a cryogenic system and/or vacuum system controlling the temperature and pressure within the cryogenic and/or vacuum chamber 40, manipulation sources 60, and/or other systems controlling the environmental conditions (e.g., temperature, humidity, pressure, and/or the like) within the cryogenic and/or vacuum chamber 40 and/or configured to manipulate and/or cause a controlled evolution of quantum states of one or more quantum objects within the confinement apparatus.

As shown in FIG. 10, in various embodiments, the controller 30 may comprise various controller elements including processing elements and/or devices 1005, memory 1010, driver controller elements 1015, a communication interface 1020, analog-digital converter elements 1025, and/or the like. For example, the processing elements and/or devices 1005 may comprise programmable logic devices (CPLDs), microprocessors, coprocessing entities, application-specific instruction-set processors (ASIPs), integrated circuits, application specific integrated circuits (ASICs), field programmable gate arrays (FPGAs), programmable logic arrays (PLAs), hardware accelerators, other processing devices and/or circuitry, and/or the like. and/or controllers. The term circuitry may refer to an entirely hardware embodiment or a combination of hardware and computer program products. In an example embodiment, the processing element and/or device 1005 of the controller 30 comprises a clock and/or is in communication with a clock.

For example, the memory 1010 may comprise non-transitory memory such as volatile and/or non-volatile memory storage such as one or more of as hard disks, ROM, PROM, EPROM, EEPROM, flash memory, MMCs, SD memory cards, Memory Sticks, CBRAM, PRAM, FeRAM, RRAM, SONOS, racetrack memory, RAM, DRAM, SRAM, FPM DRAM, EDO DRAM, SDRAM, DDR SDRAM, DDR2 SDRAM, DDR3 SDRAM, RDRAM, RIMM, DIMM, SIMM, VRAM, cache memory, register memory, and/or the like. In various embodiments, the memory 1010 may store qubit records corresponding to the qubits of quantum computer (e.g., in a qubit record data store, qubit record database, qubit record table, and/or the like stored in the classical/semiconductor-based memory 1010), a calibration table, an executable queue, computer program code (e.g., in a one or more computer languages, specialized controller language(s), and/or the like), one or more libraries, one or more waveform/control voltage series and associated meta data, and/or the like. In an example embodiment, execution of at least a portion of the computer program code stored in the memory 1010 (e.g., by a processing element and/or device 1005) causes the controller 30 to perform one or more steps, operations, processes, procedures and/or the like described herein for determining a conditional operation is to be performed in a first set of trapping regions; determining that the conditional operation is be prevented from being performed in a second set of trapping regions; identifying the first set of trapping regions; identifying the second set of trapping regions; controlling operation of switch signal generators 20 and control voltage sources 5, 10 to cause performance of a conditional motion primitive; controlling operation of control voltage sources 5, 10, manipulation sources 60, and/or the like to cause performance of the conditional operation in the first set of trapping regions; and/or the like.

In various embodiments, the driver controller elements 1015 may include one or more drivers and/or controller elements each configured to control one or more drivers. In various embodiments, the driver controller elements 1015 may comprise drivers and/or driver controllers. For example, the driver controllers may be configured to cause one or more corresponding drivers to be operated in accordance with executable instructions, commands, and/or the like scheduled and executed by the controller 30 (e.g., by the processing element and/or device 1005). In various embodiments, the driver controller elements 1015 may enable the controller 30 to operate a manipulation source 60. In various embodiments, the drivers may be laser drivers; vacuum component drivers; drivers for controlling the flow of current and/or voltage applied to RF rails 112, control electrodes 112, switches (e.g., shim switches 115, control switches 116), shim electrodes 118, and/or other electrodes used for maintaining and/or controlling the trapping potential of the confinement apparatus 100 and/or causing transport of one or more quantum objects or multi-quantum object crystals; cryogenic and/or vacuum system component drivers; and/or the like. For example, the drivers may control and/or comprise RF voltage drivers, control voltage sources 5, 10, shim voltage sources 15, switch signal generators 20, and/or other voltage sources 50 that provide voltages and/or electrical signals (e.g., periodic voltage signals, control voltage signals, and/or the like) to the control electrodes 114, shim electrodes 118, switches (e.g., shim switches 115, control switches 116), and/or RF rails 112.

In various embodiments, the controller 30 comprises means for communicating and/or receiving signals from one or more optical receiver components such as cameras, MEMs cameras, CCD cameras, photodiodes, photomultiplier tubes, and/or the like. For example, the controller 30 may comprise one or more analog-digital converter elements 1025 configured to receive signals from one or more optical receiver components, calibration sensors, and/or the like.

In various embodiments, the controller 30 may comprise a communication interface 1020 for interfacing and/or communicating with a computing entity 90. For example, the controller 30 may comprise a communication interface 1020 for receiving executable instructions, command sets, and/or the like from the computing entity 90 and providing output received from the quantum computer 910 (e.g., from an optical collection system) and/or the result of a processing the output to the computing entity 90. In various embodiments, the computing entity 90 and the controller 30 may communicate via a direct wired and/or wireless connection and/or one or more wired and/or wireless networks 70.

### Example Operation of a Controller

In various embodiments, the controller 30 is configured to control various elements of a quantum system 900 such that the quantum system performs one or more conditional operations. For example, the quantum system 900 comprises a quantum object confinement apparatus 100 confining a plurality of quantum objects within respective one-dimensional trapping regions 110 that, in an example embodiment, are arranged in a periodic or quasi-periodic array 105 of trapping regions 110. When the controller 30 determines that a conditional operation is to be performed, the controller 30 identifies a first set of trapping regions within which the conditional operation is to be performed and/or the controller 30 identifies a second set of trapping regions within performance of the conditional operation is be prevented. The controller 30 controls the operation of the switch signal generators 20 corresponding to the first set of trapping regions so as to cause the conditional operation to be performed in each trapping region of the first set of trapping regions. the controller 30 controls the operation of the switch signal generators 20 corresponding to the second set of trapping regions so as to prevent the performance of the conditional operation in each trapping region of the second set of trapping regions.

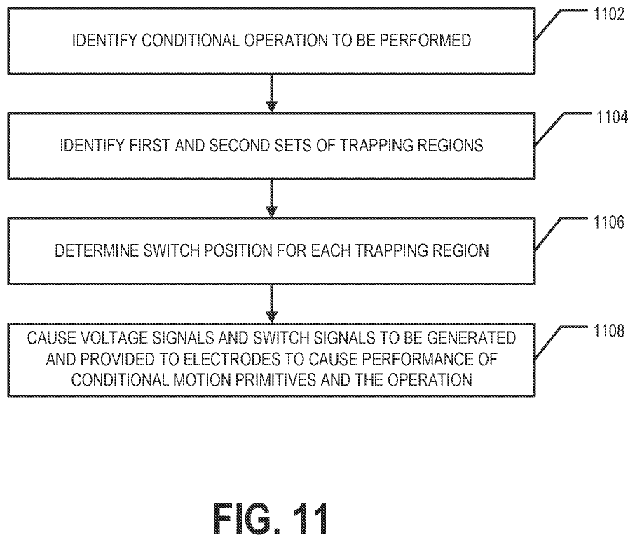

FIG. 11 provides a flowchart illustrating various processes, procedures, operations, and/or the like performed, for example by the controller 30, to cause performance of the conditional operation in the first set of trapping regions and prevent performance of the conditional operation in the second set of trapping regions. In particular, the controller 30 is configured to control operation of conditional operations in a confinement apparatus 100 where at least one control electrode is a switchable control electrode. For example, the controller 30 is configured to control operation of conditional operations in a confinement apparatus 100 where at least some of the control voltage signals applied to the control electrodes 114 are broadcast to the control electrodes of multiple trapping regions. For example, the controller 30 is configured to control operation of conditional operations in a quantum system 900 wherein the number of control voltage sources 5, 10 scales with and/or is proportional to the number of control electrodes 114 per trapping region 110 and/or does not scale with and/or is not proportional to the number of trapping regions 110 of the confinement apparatus 100.

Starting at step/operation 1102, the controller 30 identifies a conditional operation to be performed. For example, the controller 30 of the quantum system 900 is controlling operation of the quantum processor 915 to cause the quantum processor 915 to perform a quantum circuit and/or algorithm. During the performance of the quantum circuit and/or algorithm, the controller 30 determines that a conditional operation is to be performed. In various embodiments, a conditional operation is an operation to be performed in some trapping regions of a plurality of trapping regions and/or periodic or quasi-periodic array of trapping regions and to be prevented from being performed in other trapping regions of the plurality of trapping regions and/or periodic or quasi-periodic array.

As should be understood based on the above, the control electrodes of each trapping region and/or of groups of trapping regions are respectively in electrical communication with the same broadcast control voltage sources and/or switchable control voltage sources. In particular, the quantum system 900 is configured for performing operations in multiple trapping regions 110 in parallel. However, based on the quantum circuit and/or algorithm, the conditional operation should be performed on some quantum objects confined by the confinement apparatus 100 and not performed on other quantum objects confined by the confinement apparatus.

At step/operation 1104, the controller 30 determines a first set of trapping regions 110 within which the conditional operation should be performed and a second set of trapping regions 10 within which the conditional operation should not be performed. For example, the controller 30 may determine a first set of quantum objects on which the conditional operation is to be performed. The controller 30 may then determine in which trapping regions 110 the first set of quantum objects are disposed. The trapping regions 110 in which the first set of quantum objects are disposed are then identified as the first set of trapping regions and the remainder of the trapping regions are then identified as the second set of trapping regions. In another example, the controller 30 may determine a second set of quantum objects on which the conditional operation is not be performed. The controller may then determine in which trapping regions 110 the second set of quantum objects are disposed. The trapping regions 10 in which the second set of quantum objects are disposed are then identified as the second set of trapping regions and the remainder of the trapping regions are identified as the first set of trapping regions.

In various embodiments, the conditional operation may not be a binary operation (e.g., performed or prevented from being performed). For example, the conditional operation may comprise degrees to which the operation may be performed. In such embodiments, a plurality of sets of trapping regions 110 may be identified, where each set of trapping regions 110 is to have a similar degree of the conditional operation performed therein.

At step/operation 1106, the controller 30 determines a switch position for each trapping region 110. For example, the switch position determined for each trapping region 110 of the first set of trapping regions is configured to cause the performance of the conditional operation in the corresponding trapping region 110. For example, the switch position determined for each trapping region 110 of the second set of trapping regions is configured to prevent the performance of the conditional operation in the corresponding trapping region 110.

As described above, the switch position of a switch corresponding to a trapping region controls whether the performance of a conditional motion primitive in the trapping region causes one or more quantum objects disposed at an initial position of the trapping region to move to a first position of the trapping region or a second position of the trapping region, wherein the first and second positions are different positions along the corresponding one-dimensional trapping region 110. For example, in an example embodiment, the controller 30 determines that the switch position of respective switches of each trapping region of the first set of trapping regions should be set to a first switch position and the switch position of the respective switches of each trapping region of the second set of trapping regions should be set to a second switch position.

At step/operation 1108, the controller 30 controls operation of various components of the quantum system 900 to case the performance of the conditional operation in the first set of trapping regions 110 and to prevent the performance of the conditional operation in the second set of trapping regions 110. For example, the controller 30 controls the operation of the switch signal generators 20 to cause each switch (e.g., control switches 116, shim switches 115) to be in the respective switch position determined at step/operation 1106.

For example, the controller 30 controls operation of the first switch signal generator 20A such that the first switch signal generator 20A generates and provides a digital switch signal corresponding to the determined switch position for the corresponding first trapping region 110A. The switch signal is provided to the corresponding shim switch 115 and/or control switch 116A to cause the corresponding shim switch 115 and/or control switch 116A to be in the determined switch position. The operation of other switch signal generators 20 of the voltage sources 50 is similarly controlled such that each switch (e.g., shim switch 115 and/or control switch 116) corresponding to a trapping region of the plurality of trapping regions and/or periodic or quasi-periodic array of trapping regions is set to the respective determined switch position.

The controller 30 further controls the operation of the control voltage sources 5, 10, and/or shim voltage sources 15 of the voltage sources 50 such that a conditional motion primitive is performed in each of the trapping regions of the plurality of trapping regions and/or periodic or quasi-periodic array of trapping regions where whether one or more quantum objects disposed in a respective trapping region are disposed in a first position or a second position of the respective trapping region after performance of the conditional motion primitive is determined based on the switch position of a respective switch.

The controller 30 further controls operation of the control voltage sources 5, 10, shim voltage sources 15, manipulation sources 60, and/or the like to cause the performance of the conditional operation at the first position of each of the trapping regions 110 of the plurality of trapping regions and/or periodic array or quasi-periodic array of trapping regions. As should be understood, in the trapping regions of the second set of trapping regions, no quantum objects are present at the first position of the trapping region and thus the performance of the conditional operation in the trapping regions of the second set of trapping regions is prevented.

The controller 30 may further control operation of the control voltage sources 5, 10, and/or shim voltage sources 15 of the voltage sources 50 such that an inverse conditional motion primitive is performed in each of the trapping regions of the plurality of trapping regions and/or periodic or quasi-periodic array of trapping regions such that the quantum objects are again disposed at the initial positions of their respective trapping regions 110.

### Example Computing Entity

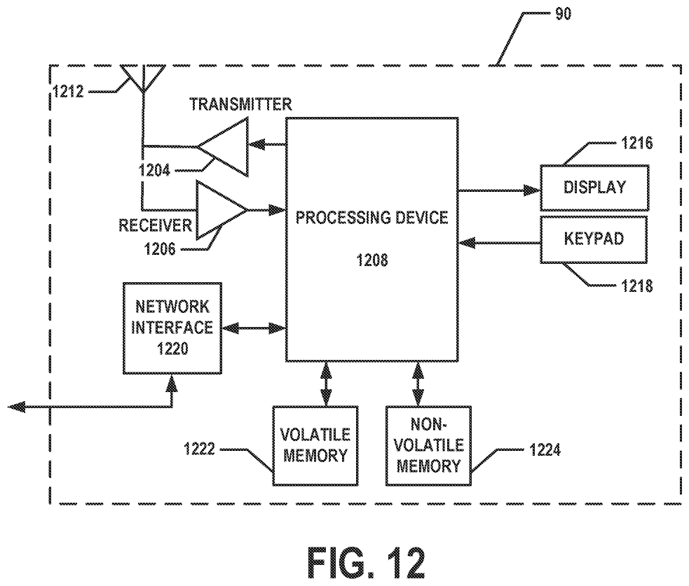

FIG. 12 provides an illustrative schematic representative of an example computing entity 90 that can be used in conjunction with embodiments of the present invention. In various embodiments, a computing entity 90 is part of a quantum system 900 and/or configured to allow a user to provide input to the quantum computer 910 (e.g., via a user interface of the computing entity 90) and receive, display, analyze, and/or the like output from the quantum computer 910.

As shown in FIG. 12, a computing entity 90 can include an antenna 1212, a transmitter 1204 (e.g., radio), a receiver 1206 (e.g., radio), and a processing device (e.g., one or more processing elements) 1208 that provides signals to and receives signals from the transmitter 1204 and receiver 1206, respectively. The signals provided to and received from the transmitter 1204 and the receiver 1206, respectively, may include signaling information/data in accordance with an air interface standard of applicable wireless systems to communicate with various entities, such as a controller 30, other computing entities 10, and/or the like. In this regard, the computing entity 90 may be capable of operating with one or more air interface standards, communication protocols, modulation types, and access types. For example, the computing entity 90 may be configured to receive and/or provide communications using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. Similarly, the computing entity 90 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1× (1×RTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol. The computing entity 90 may use such protocols and standards to communicate using Border Gateway Protocol (BGP), Dynamic Host Configuration Protocol (DHCP), Domain Name System (DNS), File Transfer Protocol (FTP), Hypertext Transfer Protocol (HTTP), HTTP over TLS/SSL/Secure, Internet Message Access Protocol (IMAP), Network Time Protocol (NTP), Simple Mail Transfer Protocol (SMTP), Telnet, Transport Layer Security (TLS), Secure Sockets Layer (SSL), Internet Protocol (IP), Transmission Control Protocol (TCP), User Datagram Protocol (UDP), Datagram Congestion Control Protocol (DCCP), Stream Control Transmission Protocol (SCTP), HyperText Markup Language (HTML), and/or the like.

Via these communication standards and protocols, the computing entity 90 can communicate with various other entities using concepts such as Unstructured Supplementary Service information/data (USSD), Short Message Service (SMS), Multimedia Messaging Service (MMS), Dual-Tone Multi-Frequency Signaling (DTMF), and/or Subscriber Identity Module Dialer (SIM dialer). The computing entity 90 can also download changes, add-ons, and updates, for instance, to its firmware, software (e.g., including executable instructions, applications, program modules), and operating system. In various embodiments, the computing entity 90 is configured to communicate via one or more wired and/or wireless networks via network interface 1220.

The computing entity 90 may also comprise a user interface device comprising one or more user input/output interfaces (e.g., a display 1216 and/or speaker/speaker driver coupled to a processing device 1208 and a touch screen, keyboard, mouse, and/or microphone coupled to a processing device 1208). For instance, the user output interface may be configured to provide an application, browser, user interface, interface, dashboard, screen, webpage, page, and/or similar words used herein interchangeably executing on and/or accessible via the computing entity 90 to cause display or audible presentation of information/data and for interaction therewith via one or more user input interfaces. The user input interface can comprise any of a number of devices allowing the computing entity 90 to receive data, such as a keypad 1218 (hard or soft), a touch display, voice/speech or motion interfaces, scanners, readers, or other input device. In embodiments including a keypad 1218, the keypad 1218 can include (or cause display of) the conventional numeric (0-9) and related keys (#, *), and other keys used for operating the computing entity 90 and may include a full set of alphabetic keys or set of keys that may be activated to provide a full set of alphanumeric keys. In addition to providing input, the user input interface can be used, for example, to activate or deactivate certain functions, such as screen savers and/or sleep modes. Through such inputs the computing entity 90 can collect information/data, user interaction/input, and/or the like.

The computing entity 90 can also include volatile storage or memory 1222 and/or non-volatile storage or memory 1224, which can be embedded and/or may be removable. For instance, the non-volatile memory may be ROM, PROM, EPROM, EEPROM, flash memory, MMCs, SD memory cards, Memory Sticks, CBRAM, PRAM, FeRAM, RRAM, SONOS, racetrack memory, and/or the like. The volatile memory may be RAM, DRAM, SRAM, FPM DRAM, EDO DRAM, SDRAM, DDR SDRAM, DDR2 SDRAM, DDR3 SDRAM, RDRAM, RIMM, DIMM, SIMM, VRAM, cache memory, register memory, and/or the like. The volatile and non-volatile storage or memory can store databases, database instances, database management system entities, data, applications, programs, program modules, scripts, source code, object code, byte code, compiled code, interpreted code, machine code, executable instructions, and/or the like to implement the functions of the computing entity 90.

### CONCLUSION

Many modifications and other embodiments of the invention set forth herein will come to mind to one skilled in the art to which the invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A quantum object confinement apparatus comprising:
one or more electrode sequences, each electrode sequence comprising a respective plurality of control electrodes configured to control the electric potential in a respective trapping region of one or more trapping regions of the quantum object confinement apparatus, wherein a first switchable control electrode of one or more switchable control electrodes of the respective plurality of control electrodes is configured to be switchably in electrical communication with a respective selected switchable control voltage source of two or more switchable control voltage sources.

2. The quantum object confinement apparatus of claim 1, wherein the one or more switchable control electrodes comprises the first switchable control electrode and a second switchable control electrode, and the first switchable control electrode and the second switchable control electrode are each configured to be switchably in electrical communication with a respective one of a first switchable control voltage source and a second switchable control voltage source of the two or more switchable control voltage sources.

3. The quantum object confinement apparatus of claim 2, further comprising one or more switches, wherein each electrode sequence of the one or more electrode sequences is associated with a respective switch of the one or more switches and the respective switch is configured to control switching of the electrical communication of the first switchable control electrode and the second switchable control electrode to respective ones of the two or more switchable voltage sources.

4. The quantum object confinement apparatus of claim 1, further comprising one or more switches, wherein each electrode sequence of the one or more electrode sequences is associated with a respective switch of the one or more switches and the respective switch is configured to control switching of the electrical communication of the one or more switchable control electrodes with the respective selected switchable control voltage sources of the two or more switchable voltage sources

5. The quantum object confinement apparatus of claim 1, wherein the respective plurality of control electrodes further comprises one or more broadcast control electrodes that are each configured to be in electrical communication with a respective broadcast control voltage source of one or more broadcast control voltage sources.

6. The quantum object confinement apparatus of claim 3, wherein the one or more electrode sequences comprises a plurality of electrode sequences and the one or more broadcast control electrodes of the respective plurality of control electrodes of the plurality of electrode sequences are configured to be in electrical communication with the one or more broadcast control voltage sources.

7. The quantum object confinement apparatus of claim 4, wherein a number of the broadcast control voltage sources scales with a number of control electrodes in the respective plurality of control electrodes and does not scale with a number of electrode sequences.

8. The quantum object confinement apparatus of claim 1, further comprising one or more switches, wherein each electrode sequence is associated with a respective switch of the one or more switches and the respective switch is configured to control switching among two or more switch positions, each respective switch position of the two or more switch positions configured to cause the first switchable control electrode to be in electrical communication with a selected one of two or more selectable control voltage sources and to cause the second switchable control electrode to be in electrical communication with a different one of the two or more selectable control voltage sources.

9. The quantum object confinement apparatus of claim 8, wherein the respective switch is a double-pole double-throw switch.

10. The quantum object confinement apparatus of claim 8, wherein the respective switch is configured to be controlled by a respective switch signal.

11. The quantum object confinement apparatus of claim 10, wherein the respective switch signal is a digital signal.

12. The quantum object confinement apparatus of claim 8, wherein the one or more electrode sequences comprises a plurality of electrode sequences, the one or more switches comprises a plurality of switches, and each switch of the plurality of switches is controlled independently.

13. The quantum object confinement apparatus of claim 1, wherein the respective trapping region of the one or more trapping regions is a cyclic path trapping region, the two or more switchable control voltage signals are configured to provide a plurality of control voltage signals and the plurality of control voltage signals are partitioned into two subsets of voltage signals, the two subsets of voltage signals consisting of a left partition and a right partition, and the respective plurality of control electrodes are configured to (a) when the first switchable control electrode is in electrical communication with the first switchable control voltage source, the plurality of control electrodes are each configured to be in electrical communication with a respective control voltage signal of the left partition, the voltage signals of the left partition configured to cause one or more potential wells formed by application of the voltage signals of the left partition on respective electrodes of the respective plurality of control electrodes to move about the cyclic path trapping region in a first direction and (b) when the first switchable control electrode is in electrical communication with the second switchable control voltage source, the plurality of control electrodes are each configured to be in electrical communication with a respective control voltage signal of the right partition, the voltage signals of the right partition configured to cause the one or more potential wells formed by application of the voltage signals of the right partition on respective electrodes of the respective plurality of control electrodes to move about the cyclic path trapping region in a second direction.

14. A system comprising:
two or more switchable control voltage sources each configured to generate a respective switchable control voltage signal;
a quantum object confinement apparatus comprising one or more electrode sequences, each electrode sequence of the one or more electrode sequences comprising a respective plurality of control electrodes configured to control the electric potential in a respective trapping region of one or more trapping regions of the quantum object confinement apparatus, wherein a first switchable control electrode of one or more switchable control electrodes of the respective plurality of control electrodes are each configured to be switchably in electrical communication with a respective selected switchable control voltage source of two or more switchable control voltage sources such that a respective selected switchable control voltage signal of two or more switchable control voltage signals is applied thereto; and
a controller configured to control operation of each of the two or more switchable control voltage sources, and with which of the two or more switchable control voltage sources the set of one or more switchable control electrodes are respectively in electrical communication.

15. The system of claim 14, further comprising one or more broadcast control voltage sources each configured to generate a respective broadcast control voltage signal, wherein the respective plurality of control electrodes further comprises one or more broadcast control electrodes that are each configured to be in electrical communication with a respective broadcast control voltage source of the one or more broadcast control voltage sources such that the respective broadcast control voltage signal is applied thereto.

16. The system of claim 15, wherein the one or more electrode sequences comprises a plurality of electrode sequences and the one or more broadcast control electrodes of the respective plurality of control electrodes of the plurality of electrode sequences are configured to be in electrical communication with the one or more broadcast control voltage sources.

17. The system of claim 16, wherein a number of the broadcast control voltage sources is proportional to a number of broadcast control electrodes in the respective plurality of control electrodes and is not proportional to a number of electrode sequences.

18. The system of claim 14, wherein the quantum object confinement apparatus further comprises one or more switches, wherein each electrode sequence is associated with a respective switch of the one or more switches and the respective switch is configured to control switching among two or more switch positions, each respective switch position of the two or more switch positions configured to cause the set of one or more switchable control electrodes to be in electrical communication with a selected set of one of two or more selectable control voltage sources.

19. The system of claim 18, wherein the respective switch is a double-pole double-throw switch.

20. The system of claim 18, further comprising one or more switch signal generators, wherein the controller is configured to control operation of the one or more switch signal generators and the respective switch is configured to be controlled by a respective switch signal generated by a respective switch signal generator of the one or more switch signal generators.

21. The system of claim 20, wherein the respective switch signal is a digital signal.

22. The system of claim 18, wherein the one or more electrode sequences comprises a plurality of electrode sequences, the one or more switches comprises a plurality of switches, the one or more switch signal generators comprises a plurality of switch signal generators, and the controller is configured control operation of each switch signal generator of the plurality of switch signal generators independently.

23. The system of claim 14, wherein the respective trapping region of the one or more trapping regions is a cyclic path trapping region, the two or more switchable control voltage signals are configured to provide a plurality of control voltage signals and the plurality of control voltage signals are partitioned into two subsets of voltage signals, the two subsets of voltage signals consisting of a left partition and a right partition, and the respective plurality of control electrodes are configured to (a) when the first switchable control electrode is in electrical communication with the first switchable control voltage source, the plurality of control electrodes are each configured to be in electrical communication with a respective control voltage signal of the left partition, the voltage signals of the left partition configured to cause one or more potential wells formed by application of the voltage signals of the left partition on respective electrodes of the respective plurality of control electrodes to move about the cyclic path trapping region in a first direction and (b) when the first switchable control electrode is in electrical communication with the second switchable control voltage source, the plurality of control electrodes are each configured to be in electrical communication with a respective control voltage signal of the right partition, the voltage signals of the right partition configured to cause the one or more potential wells formed by application of the voltage signals of the right partition on respective electrodes of the respective plurality of control electrodes to move about the cyclic path trapping region in a second direction.

24. A system comprising:
two or more switchable control voltage sources each configured to generate a respective switchable control voltage signal;
a plurality of broadcast control voltage sources each configured to generate a respective broadcast control voltage signal;
a quantum object confinement apparatus comprising a plurality of electrode sequences, each electrode sequence comprising a respective plurality of control electrodes configured to control the electric potential in a respective trapping region of a plurality of trapping regions of the quantum object confinement apparatus, wherein:
one or more first switchable control electrodes of the respective plurality of control electrodes are each configured to be switchably in electrical communication with a respective set of selected switchable control voltage source of two or more switchable control voltage sources such that a respective subset of selected switchable control voltage signals of two or more switchable control voltage signals is applied thereto, and
a plurality of broadcast control electrodes of the respective plurality of control electrodes are each in electrical communication with a respective broadcast control voltage source of the plurality of broadcast control voltage sources such that the respective broadcast control voltage source is in electrical communication with respective broadcast control electrodes of at least two electrode sequences; and
a controller configured to control operation of each of the two or more switchable control voltage sources, and with which of the two or more switchable control voltage sources the set of one or more switchable control electrodes are respectively in electrical communication.

25. The system of claim 24, further comprising a plurality of switch signal generators each configured to generate a respective switch signal, and
wherein:
the quantum object confinement apparatus further comprises a plurality of switches,
each electrode sequence is associated with a respective switch of the plurality of switches,
the respective switch is configured to control switching among two or more switch positions, each respective switch position of the two or more switch positions configured to cause the set of one or more switchable control electrodes to be in electrical communication with a selected subset of two or more selectable control voltage sources,
the respective switch is configured to be controlled by a respective switch signal generated by a respective switch signal generator of the plurality of switch signal generators, and
the controller is configured to individually control operation of each of the plurality of switch signal generators.

26. The system of claim 25, wherein the controller is configured to perform a conditional operation in a subset of the plurality of trapping regions at least in part by controlling the operation of the plurality of switch signal generators such that (a) for each electrode sequence for which the corresponding trapping region is part of the subset of the plurality of trapping regions within which the conditional operation is to be performed, the respective switch is in a first switch position of the two or more switch positions and (b) for each electrode sequence for which the corresponding trapping region is not part of the subset of the plurality of trapping regions within which the conditional operations is to be performed, the respective switch is in a second switch position of the two or more switch positions.

27. The system of claim 25, wherein the controller is configured to control operation of each of the two or more switchable control voltage sources, the plurality of broadcast control voltage sources, and the plurality of switch signal generators such that a respective quantum object confined in the respective trapping region moves along the respective trapping region in (a) a first direction when the respective switch is in the first position and (b) a second direction when the respective switch is in the second position.

28. The system of claim 25, wherein the controller is configured to:
identify an operation to be performed;
identify one or more trapping regions of the plurality of trapping regions within which the operation is to be performed;
determine a respective switch position of the two or more switch positions for each trapping region of the plurality of trapping regions based on whether the operation is to be performed in the respective trapping region;
control operation of the plurality of switch signal generators based on the respective switch positions determined for each trapping region of the plurality of trapping regions; and
control operation of first switchable control voltage source, the second switchable control voltage source, and the plurality of broadcast control voltage sources to enable performance of the operation within the one or more trapping regions within which the operation is to be performed.

29. The system of claim 28, wherein the controller is further configured to control operation of first switchable control voltage source, the second switchable control voltage source, and the plurality of broadcast control voltage sources to prevent performance of the operation within trapping regions of the plurality of trapping regions within which the operation is not to be performed.

30. The system of claim 24, wherein the quantum object confinement apparatus further comprises respective shim electrodes each associated with respective trapping regions of the plurality of trapping regions and a shim voltage source is configured to apply a shim voltage thereto that is configured to cause a resulting electric field that corrects from stray electric fields and/or manufacturing imperfections.

31. The system of claim 30, wherein the shim electrode is in electrical communication with a capacitor and the capacitor is in electrical communication with a switch that enables the capacitor to be switched between (a) being in electrical communication with the shim voltage source and (b) not being in electrical communication with the shim voltage source.

32. The system of claim 31, wherein applying the shim voltage source to the shim electrode comprises the steps of:
closing the switch such that the capacitor is in electrical communication with the shim voltage source causing the capacitor to be charged to the shim voltage; and
opening the switch such that the capacitor maintains the shim voltage.

33. The system of claim 30, wherein the controller is configured to:
identify an operation to be performed;
identify one or more trapping regions of the plurality of trapping regions within which the operation is to be performed;
determine a respective shim signal sign for each trapping region of the plurality of trapping regions based on whether the operation is to be performed in the respective trapping region, wherein the respective shim signal sign for the respective trapping region determines whether the respective shim electrode of the respective trapping region is in electrical communication with the first shim voltage source or the second shim voltage source;
control operation of a plurality of switch signal generators based on the respective shim signal sign determined for each trapping region of the plurality of trapping regions; and
control operation of first switchable control voltage source, the second switchable control voltage source, and the plurality of broadcast control voltage sources to enable performance of the operation within the one or more trapping regions within which the operation is to be performed.

34. The system of claim 24, wherein the controller is configured to cause performance of a conditional operation in each of a first subset of the plurality of trapping regions and prevent performance of the conditional operation in each of a second subset of the plurality of trapping regions.

35. The system of claim 34, wherein the conditional operation is at least one of: a junction swap operation, a linear swap operation, a partial row or column shift, arbitrary quantum object sorting, gating of one or more quantum objects, cooling of quantum objects, measurement of quantum objects, initialization of quantum objects, position swapping of quantum objects located within a same trapping region, loading or reloading of quantum objects, replacement of lost quantum objects from anther trapping region, interaction of a quantum object with a local field, or another transport or non-transport operation.

36. The system of claim 24, wherein the plurality of trapping regions forms a periodic array or quasi-periodic array of trapping regions.

37. The system of claim 24, wherein the plurality of broadcast control voltage sources comprise a first set of broadcast control voltage sources and a second set of broadcast control voltage sources and the plurality of broadcast control electrodes of a given electrode sequence are selectively in electrical communication with respective broadcast control voltage sources of the first set of broadcast sources or the second set of broadcast sources so as to reduce cross-talk between sequences of electrodes of the plurality of sequences of electrodes.

38. The system of claim 37, wherein the plurality of broadcast control electrodes of the given electrode sequence are selectively in electrical communication with the respective broadcast control voltage sources of the first set of broadcast sources or the second set of broadcast sources based on at least one of (a) a switch position of the respective switch of the given electrode sequence or (b) the switch position of the respective switch of a neighboring electrode sequence.

39. The system of claim 38, wherein a trapping region of the given electrode sequence and a trapping region of the neighboring electrode sequence are joined to one another via a junction.

40. A controller configured to control operation of a quantum system,
wherein the quantum system comprises two or more first switchable control voltage sources, a plurality of broadcast control voltage sources, and a quantum object confinement apparatus comprising a plurality of electrode sequences that each define a respective trapping region, each electrode sequence of the plurality of electrode sequences comprising a first switchable control electrode configured to be switchably in electrical communication with a selected switchable control voltage source of two or more switchable control voltage sources, and a plurality of broadcast control electrodes each configured to be in electrical communication with a respective broadcast control voltage source of the plurality of broadcast control voltage sources, and
the controller is configured to control operation of each of the two or more switchable control voltage sources, and the plurality of broadcast control voltage sources such that respective quantum objects disposed in a first subset of the plurality trapping regions are moved in a first direction along respective trapping regions and the respective quantum objects disposed in a second subset of the plurality of trapping regions are moved in a second direction along the respective trapping regions,
wherein the plurality of broadcast control electrodes corresponding to trapping regions in the first subset of trapping regions are respectively in electrical communication with the same plurality of broadcast control voltage sources as the plurality of broadcast control electrodes corresponding to trapping regions in the second subset of trapping regions.

41. The controller of claim 40, wherein the first switchable control electrode corresponding to trapping regions in the first subset of trapping regions are in electrical communication with a same one of the two or more switchable control voltage sources.

42. The controller of claim 40, wherein the first switchable control electrode corresponding to trapping regions in the first subset of trapping regions are in electrical communication with a different one of the two or more switchable control voltage sources with respect to the first switchable control electrode corresponding to trapping regions in the second subset of trapping regions.

43. The controller of claim 40, wherein:
the quantum system further comprises a shim voltage source configured to generate a shim voltage,
the quantum object confinement apparatus further comprises respective shim electrodes each associated with respective trapping regions of the plurality of trapping regions, and
a respective shim electrode is selectively in electrical communication with the shim voltage source.

44. The controller of claim 40, wherein the plurality of trapping regions forms a periodic array of trapping regions or a quasi-periodic array of trapping regions.
